(19) United States
(12) Patent Application Publication
(10) Pub. No.: US 2024/0311708 A1
(43) Pub. Date: Sep. 19, 2024

(54) OPERATION PLAN CREATION DEVICE AND OPERATION PLAN CREATION METHOD

(71) Applicant: IHI Corporation, Tokyo (JP)

(72) Inventors: Kenichi HAMAGUCHI, Tokyo (JP); Akinobu INAMURA, Tokyo (JP)

(73) Assignee: IHI Corporation, Tokyo (JP)

(21) Appl. No.: 18/596,694

(22) Filed: Mar. 6, 2024

(30) Foreign Application Priority Data
Mar. 14, 2023 (JP) 2023-039489

(51) Int. Cl. G06Q 10/0631

(52) U.S. Cl. CPC G06Q 10/0631

(57) ABSTRACT

An operation plan creation device includes a prediction unit configured to acquire a predicted value of an amount of electric power which is able to be supplied to a process device and which includes electric power originating from renewable energy and a simulation arithmetic unit configured to create an operation plan based on the predicted value and an operational preparation required time period indicating a required time period for an operational preparation.

### CROSS-REFERENCE TO RELATED APPLICATIONS

This application claims the benefit of priority from Japanese Patent Application No. 2023-039489, filed on Mar. 14, 2023, the entire contents of which are incorporated herein by reference.

### BACKGROUND

The present disclosure relates to an operation plan creation device and an operation plan creation method.

Reduction of greenhouse gas emission in use of energy is an urgent issue for realizing a sustainable society. Countermeasures for reduction of carbon dioxide in manufacturing industries have increased.

Particularly, a technique (methanation) of producing synthetic methane by causing carbon dioxide and hydrogen to react has attracted much attention in the gas industry. Synthetic methane is produced from carbon dioxide discharged from factories. The produced synthetic methane can be used as an alternative fuel to natural gas in the corresponding factories. The produced synthetic methane can be injected into town gas pipes and can also be used in other factories or ordinary households.

Existing town gas infrastructure can be utilized to use synthetic methane. Accordingly, methanation is anticipated as key technology for realizing carbon neutralization. In order to realize carbon neutralization using synthetic methane, it is preferable that electric power used to produce synthetic methane be electric power originating from renewable energy such as wind power generation and photovoltaic power generation.

Japanese Unexamined Patent Publication No. 2020-54085, PCT International Publication No. WO 2020/121436, Japanese Unexamined Patent Publication No. 2022-020978, Japanese Unexamined Patent Publication No. 2021-164178, Japanese Patent No. 6189448, Japanese Unexamined Patent Publication No. 2022-25398, and Japanese Patent No. 7008297 disclose operation techniques associated with a process device such as a methanation reactor. In the following description, the methanation reactor is simply referred to as a “methanation device.”

Japanese Unexamined Patent Publication No. 2020-54085 discloses a technique associated with a facility including a photovoltaic power generator, a hydrogen production device, and a storage battery. In the technique disclosed in Japanese Unexamined Patent Publication No. 2020-54085, the storage battery is charged with surplus electric power when the surplus electric power is generated through photovoltaic power generation. This technique produces hydrogen when an amount of electric power stored in the storage battery is greater than a set value (see S110 in FIG. 2 in Japanese Unexamined Patent Publication No. 2020-54085).

PCT International Publication No. WO 2020/121436 discloses a technique that is applied to a system including a hydrogen production device. In the technique disclosed in PCT International Publication No.

WO 2020/121436, a preparation time period is provided before a demand-response supply and demand adjusting time period when electric power supply and demand of demand-response or the like is adjusted using the hydrogen production device. In this technique, power consumption of a hydrogen production system is matched with a target value before the supply and demand adjusting time period by activating the hydrogen production device in the preparation time period.

Japanese Unexamined Patent Publication No. 2022-020978 discloses a technique that is applied to a system including a power generator such as a photovoltaic power generator. In the technique disclosed in Japanese Unexamined Patent Publication No. 2022-020978, power consumption of a load is increased, for example, by causing the load to consume electric power when electric power generated in the power generator such as a photovoltaic power generator is surplus and a state of charge in a storage battery is equal to or greater than a predetermined value.

Japanese Unexamined Patent Publication No. 2021-164178 discloses a technique that is applied to a system including a renewable energy generator and a storage battery. In the technique disclosed in Japanese Unexamined Patent Publication No. 2021-164178, first, demand for electric power and an amount of electric power generated by the renewable energy generator are predicted and a residual storage capacity of the storage battery is predicted. This technique decreases or increases power consumption of a load when a result indicating that the residual storage capacity of the storage battery is equal to or less than a threshold value or equal to or greater than the threshold value is acquired.

Japanese Patent No. 6189448 discloses a technique that is applied to a system including a power generator using renewable energy, a hydrogen production device, a fuel cell, and a storage battery. In the technique disclosed in Japanese Patent No. 6189448, a predicted value of an amount of electric power generated by the renewable-energy power generation device and a predicted value of electric power demand are acquired. In this technique, then, a state of charge of the storage battery and power consumption of the hydrogen production device in the daytime are determined and an amount of electric power discharged from the storage battery and an amount of electric power generated from the fuel cell in the nighttime are determined. This system consumes electric power and/or charges the storage battery in the daytime and generates electric power and/or discharges the storage battery in the nighttime.

Japanese Unexamined Patent Publication No. 2022-25398 discloses a technique that is applied to a system including a photovoltaic power generation facility and an air-conditioning facility. In the technique disclosed in Japanese Unexamined Patent Publication No. 2022-25398, first, an amount of surplus electric power is predicted based on a predicted value of an amount of electric power generated by photovoltaic power generation and a predicted value of an amount of consumed electric power. Then, in this technique, a time period in which the predicted amount of surplus electric power exceeds a predetermined set value of power consumption in the air-conditioning facility is calculated. Then, in this technique, when an excess time period exceeding the set value is greater than a continuous operation set time, the excess time period is set as an operation time period of the air-conditioning facility using surplus electric power.

Japanese Patent No. 7008297 discloses a technique that is applied to a system including a hydrogen production device and a hydrogen storage device. In the technique disclosed in Japanese Patent No. 7008297, an amount of electric power generated using renewable energy and a load of an electric power consumer are predicted, and surplus electric power is estimated from the predicted values. In this technique, a hydrogen production plan and a hydrogen storage plan are created using the estimated surplus electric power. In this technique, a start time of a precooling/preheating temperature of a hydrogen storage device (a hydrogen-absorbing alloy) is set (see FIG. 2 in Japanese Patent No. 7008297)

### SUMMARY

According to an aspect of the present disclosure, there is provided an operation plan creation device for creating an operation plan for a device that is able to switch from a non-producible state in which a product is not acquired even with inputting of electric power to a producible state in which a product is acquired with inputting of electric power by making an operational preparation. The operation plan creation device includes: a prediction unit configured to acquire a predicted value of an amount of electric power which is able to be supplied to the device and which includes electric power originating from renewable energy; and a processing unit configured to create the operation plan based on the predicted value and an operational preparation required time period indicating a required time period for the operational preparation.

### BRIEF DESCRIPTION OF THE DRAWINGS

FIG. 1 is a diagram illustrating a microgrid to which an operation plan creation device according to a first embodiment is applied.

FIG. 2 is a diagram illustrating a functional configuration of the operation plan creation device according to the first embodiment.

FIG. 3 is a diagram illustrating a hardware configuration of the operation plan creation device according to the first embodiment.

FIG. 4 is a conceptual diagram of a surplus electric power that is generated in a planned section.

FIG. 5 is a diagram illustrating a relationship between power consumption and an amount of production in a process device.

FIG. 6 is a conceptual diagram of simulation of an operational preparation and production.

FIG. 7 is a flowchart illustrating principal steps of an operation plan creation method which is performed by the operation plan creation device according to the first embodiment.

FIG. 8 is a diagram illustrating a microgrid to which an operation plan creation device according to a second embodiment is applied.

FIG. 9 is a diagram illustrating a functional configuration of the operation plan creation device according to the second embodiment.

FIG. 10 is a table illustrating meanings of (a set of) symbols constituting a mixed integer programming problem.

FIG. 11 is a table illustrating arrangement of meanings of symbols (parameters and dependent variables) constituting a mixed integer programming problem.

FIG. 12 is a table illustrating meanings of symbols (decision variables) constituting a mixed integer programming problem.

FIG. 13 is a diagram illustrating the concepts of flags.

FIG. 14 is a flowchart illustrating principal steps of an operation plan creation method which is performed by the operation plan creation device according to the second embodiment.

FIG. 15 is a table illustrating arrangement of numerical examples which are used in a calculation example.

FIG. 16 is a graph illustrating a predicted value of an amount of electric power generated by photovoltaic power generation which is used in a calculation example.

FIG. 17 is a graph illustrating an amount of electric power as a result of a calculation example.

FIG. 18 is a graph illustrating an amount of production as a result of a calculation example.

FIG. 19 is a graph illustrating a start time of an operational preparation as a result of a calculation example.

FIG. 20 is a diagram illustrating another example of a system to which an operation plan obtained by the operation plan creation device and the operation plan creation method is applied.

### DETAILED DESCRIPTION

A methanation reaction using a catalyst is an exothermic reaction. Since an amount of synthesized methane decreases when the temperature is excessively raised, it is necessary to perform slow heating after the reaction has started. In order to start the methanation reaction, the temperature needs to be raised to about 250° C. to 450° C. Accordingly, it is difficult to instantaneously start production of methane in a non-producible state under the normal temperature and the normal pressure.

For the aforementioned reason, a methanation device needs to perform a temperature raising operation before production is started. A time period required for the temperature raising operation is affected by a heating type such as an electric heater type or a steam heating type, the scale of the methanation device, and a device temperature at the time of start of temperature raising. The temperature raising operation may require, for example, a time period of 15 minutes to 5 hours.

As described in the methanation device, allocation of electric power of renewable energy to power consumption in a process device requiring a time period for preparation such as temperature raising or pressure raising before it operates is not considered in the techniques disclosed in the aforementioned patent documents. Accordingly, when an operation of allocating electric power of renewable energy to power consumption in a process device is planned and the techniques disclosed in the patent documents are applied thereto, there is a likelihood of creation of an operation plan which is not executable.

The present disclosure provides an operation plan creation device and an operation plan creation method that can curb creation of an operation plan which is not executable.

### SUMMARY

According to an aspect of the present disclosure, there is provided an operation plan creation device for creating an operation plan for a device that is able to switch from a non-producible state in which a product is not acquired even with inputting of electric power to a producible state in which a product is acquired with inputting of electric power by making an operational preparation. The operation plan creation device includes a prediction unit configured to acquire a predicted value of an amount of electric power which is able to be supplied to the device and which includes electric power originating from renewable energy and a processing unit configured to create the operation plan based on the predicted value and an operational preparation required time period indicating a required time period for the operational preparation.

The operation plan creation device creates an operation plan based on the predicted value of electric power and the operational preparation required time period indicating a required time period for the operational preparation. Accordingly, since the operational preparation required time period is reflected in the acquired operation plan, it is possible to curb creation of an operation plan which is not executable.

In the operation plan creation device according to the embodiment of the present disclosure, the operation plan may include a plurality of startable time candidates which are able to be selected as a time at which the operational preparation is started. The processing unit may include a total evaluation quantity calculating unit. The total evaluation quantity calculating unit may be configured to perform: calculating a total evaluation quantity based on an amount of electric power consumed in the device to produce the product based on the predicted value and the operational preparation required time period based on the premise that the operational preparation is started at a startable time candidate selected out of the plurality of startable times for each of the plurality of startable time candidates; extracting at least one total evaluation quantity indicating a maximum value as a maximum total evaluation quantity out of a plurality of total evaluation quantities acquired for each of the plurality of startable time candidates; and selecting the startable time candidate corresponding to the at least one maximum total evaluation quantity as a first candidate which is a candidate for a time at which the operational preparation is started. With this configuration, it is possible to determine a time at which the operational preparation is started based on a total amount of production.

In the operation plan creation device according to the embodiment of the present disclosure, the processing unit may further include a total evaluation quantity determining unit. The total evaluation quantity determining unit may be configured to select at least one startable time candidate in which the maximum total evaluation quantity is equal to or greater than a threshold value as a second candidate out of the at least one first candidate by comparing the at least one maximum total evaluation quantity with the threshold value. With this configuration, it is possible to determine a time at which the operational preparation is started based on the total amount of production.

In the operation plan creation device according to the embodiment of the present disclosure, the processing unit may further include a start time determining unit. The start time determining unit may be configured to employ a latest time out of the second candidates as a start time at which the operational preparation is started when a plurality of the second candidates is selected by the total evaluation quantity determining unit. With this configuration, it is possible to determine a time at which the operational preparation is started based on a total amount of production.

In the operation plan creation device according to the embodiment of the present disclosure, the prediction unit may acquire the predicted value by predicting electric power output from a renewable-energy power generation device. With this configuration, it is possible to obtain an operation plan for a device that operates with electric power supplied from the renewable-energy power generation device.

In the operation plan creation device according to the embodiment of the present disclosure, the prediction unit may acquire the predicted value by predicting electric power output from a renewable-energy power generation device and acquiring a schedule indicating electric power output from an energy storage device and electric power input to the energy storage device. With this configuration, it is possible to obtain an operation plan for a device that operates with electric power supplied from the renewable-energy power generation device and electric power input to or output from the energy storage device.

In the operation plan creation device according to the embodiment of the present disclosure, the total evaluation quantity may be a total amount of production of the product which is produced by the device and calculated based on the amount of consumed electric power. With this configuration, it is possible to perform evaluation based on a total amount of production of the product.

In the operation plan creation device according to the embodiment of the present disclosure, the total evaluation quantity may be an amount of consumed electric power. With this configuration, it is possible to perform evaluation based on an amount of electric power required for producing the product.

In the operation plan creation device according to the embodiment of the present disclosure, the processing unit may include: a generation unit configured to prepare a programming problem including a term defined to include an amount of electric power consumed in the device to acquire the product in the device at a predetermined time and a term indicating whether the device is able to produce the product with reception of the electric power; and an arithmetic unit configured to acquire a candidate for the operation plan by solving the programming problem. With this configuration, it is possible to create an operation plan in consideration of the operational preparation required time period using mathematical programming.

In the operation plan creation device according to the embodiment of the present disclosure, the processing unit may further include an employment determining unit configured to employ the candidate for the operation plan as the operation plan when total evaluation value defined to include the amount of electric power consumed in the device and acquired based on the operation plan is equal to or greater than a threshold value. With this configuration, it is possible to determine whether an operation plan is to be employed using the total evaluation value.

According to another aspect of the present disclosure, there is provided an operation plan creation method of creating an operation plan for a device that is able to switch from a non-producible state in which a product is not acquired even with inputting of electric power to a producible state in which a product is acquired with inputting of electric power by making an operational preparation. The operation plan creation method includes: acquiring a predicted value of an amount of electric power which is able to be supplied to the device and which includes electric power originating from renewable energy; and creating the operation plan based on the predicted value and an operational preparation required time period indicating a required time period for the operational preparation. With this method, it is also possible to create an operation plan in consideration of the operational preparation required time period. Accordingly, it is possible to curb creation of an operation plan which is not executable.

According to the present disclosure, it is possible to provide an operation plan creation device and an operation plan creation method that can curb creation of an operation plan which is not executable.

### First Embodiment

Hereinafter, an operation plan creation device and an operation plan creation method according to a first embodiment will be described in detail with reference to the accompanying drawings. The same elements in description with reference to the drawings will be referred to by the same reference signs and repeated description thereof will be omitted.

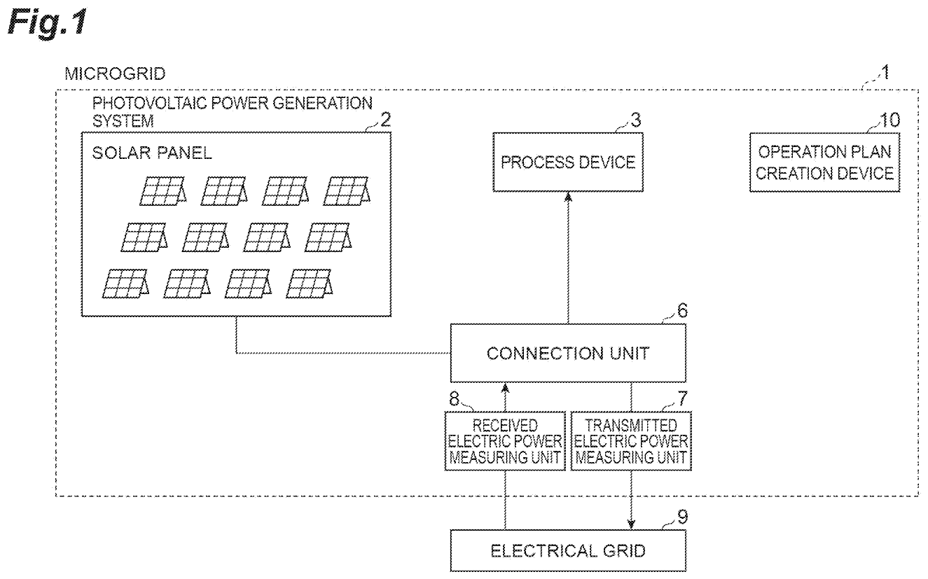

FIG. 1 illustrates a microgrid 1 to which an operation plan creation device 10 according to the first embodiment is applied. The microgrid 1 includes a photovoltaic power generation system 2, a process device 3, a connection unit 6, a transmitted electric power measuring unit 7, and a received electric power measuring unit 8. The microgrid 1 is connected to an external electrical grid 9. The microgrid 1 can transmit electric power to the electrical grid 9. The microgrid 1 can also receive electric power from the electrical grid 9.

The photovoltaic power generation (PV) system 2 generates electric power based on renewable energy. The photovoltaic power generation system 2 includes a solar panel and a PV-PCS (power conditioner). The PV-PCS converts DC electric power to AC electric power. A power generation system using renewable energy is not limited to the photovoltaic power generation system 2. The power generation system using renewable energy may be, for example, a wind power generation system or a geothermal power generation system.

The power generation system using renewable energy may be a biomass power generation system or a garbage power generation system. An amount of electric power generated in a photovoltaic power generation system is affected by weather conditions (such as solar radiation, temperature, and snowfall). As a result, the amount of electric power generated in a photovoltaic power generation system varies. An amount of electric power generated in a wind power generation system is affected by a wind speed. As a result, the amount of electric power generated in a wind power generation system varies. Characteristics of biomass or garbage (such as waste or sludge) serving as a raw material of the biomass power generation system and the garbage power generation system are not stable in general. Outputs of the biomass power generation system and the garbage power generation system are not stable due to mixture of matter which is not suitable for temporary incineration or the like.

The process device 3 requires time until production of a product is started by consuming electric power. The process device 3 is, for example, a methanation device. The product of the process device 3 is, for example, gas such as methane. When the product is gas, the process device 3 causes the produced gas to flow into a town gas pipe. When the product is gas, the process device 3 compresses or liquefies the produced gas and then charges a container with the compressed gas or the liquefied gas. The container may be stored or transported. In any case, the produced product goes out of the microgrid 1.

The process device 3 can switch from a non-producible state to a producible state. The non-producible state is a state in which a product cannot be produced in spite of inputting of electric power by making an operational preparation of the process device 3. The producible state is a state in which a product can be produced with inputting of electric power. The process device 3 is an electrical load device.

The connection unit 6 distributes electric power to constituents.

Electric power distributed by the connection unit 6 may include electric power supplied from the external electrical grid 9. The connection unit 6 is, for example, a power distribution board. The received electric power measuring unit 8 measures electric power received from an external system (the electrical grid 9). The transmitted electric power measuring unit 7 measures electric power transmitted to the external system (the electrical grid 9).

When electric power generated using renewable energy cannot be consumed by the process device 3, remaining electric power is finally transmitted to the electrical grid 9. In general, a transmitting unit price is lower than a receiving unit price. Accordingly, there are demands for consumption of surplus electric power in the process device 3 for transmission of electric power. Surplus electric power may not be able to be transmitted to the electrical grid 9 in association with an available capacity of the electrical grid 9. When surplus electric power cannot be transmitted to the electrical grid 9, the output of the photovoltaic power generation system 2 is suppressed. Suppression of the output of the photovoltaic power generation system 2 causes an opportunity loss of power generation, which is not preferable. In the first embodiment, it is assumed that electric power generated by photovoltaic power generation is consumed in the microgrid 1 as much as possible.

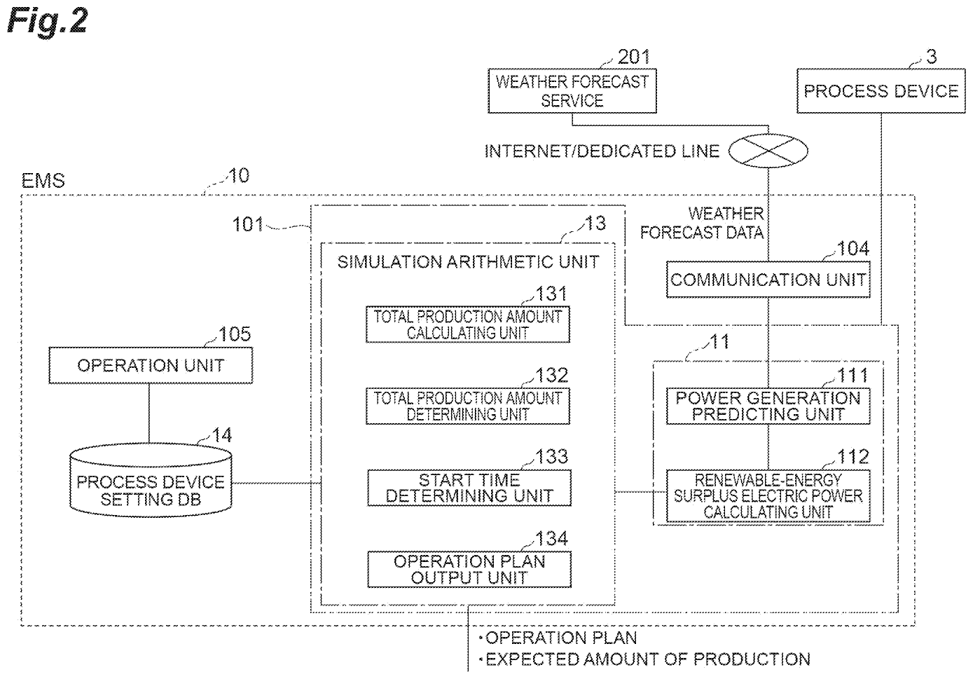

FIG. 2 is a diagram illustrating functions of the operation plan creation device 10. In FIG. 2, only functions (an operation plan creating function) intended by the operation plan creation device 10 according to the first embodiment are illustrated. FIG. 2 does not illustrate the other functions such as a state monitoring function and an operation command function of the process device 3, a trend data storage function, and a demand monitoring function. Communication between the operation plan creation device 10 and the devices may be wired communication using an analog signal or Ethernet (registered trademark). Communication between the operation plan creation device 10 and the devices may be wireless communication. The communication protocol may be Modbus/TCP or ECHOENT Lite (registered trademark).

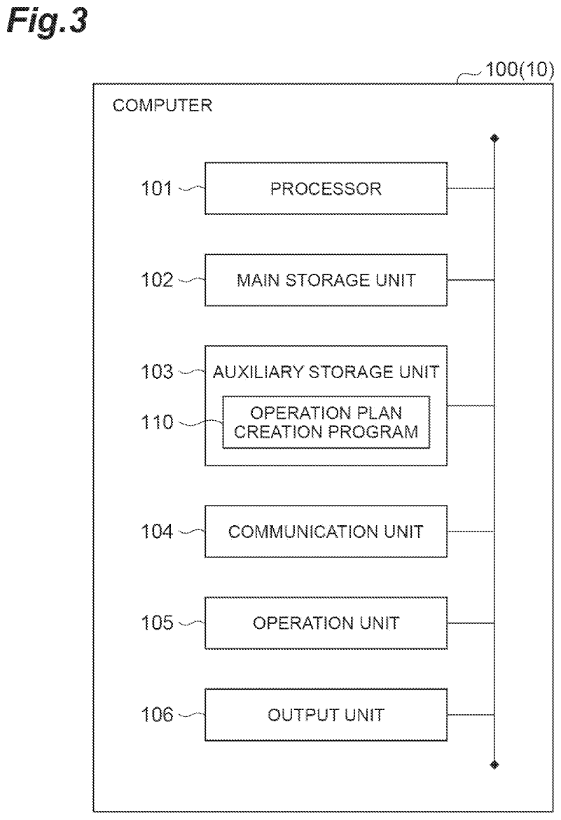

In the operation plan creation device 10, parameters associated with creation of an operation plan are set and changed by an operation unit 105. Specifically, a user sets the parameters associated with creation of an operation plan using a screen of a computer 100 (see FIG. 3) and the operation unit 105 such as a keyboard or a mouse. The set parameters are stored in a setting database (DB).

A hardware configuration of the operation plan creation device 10 will be described below with reference to FIG. 3. FIG. 3 illustrates an example of the hardware configuration of the operation plan creation device 10. The computer 100 includes a processor 101 which is a central processing unit (CPU), a main storage unit 102, an auxiliary storage unit 103, a communication unit 104, an operation unit 105, and an output unit 106. The operation plan creation device 10 is constituted by one or more computers 100 including the hardware and software such as a program.

When the operation plan creation device 10 is constituted by a plurality of computers 100, the computers 100 may be connected locally. The computers 100 may be connected via a communication network such as the Internet or an intranet. The operation plan creation device 10 which is logically single is constructed by this connection.

The processor 101 executes an operating system, an application program, and the like. The main storage unit 102 includes a read only memory (ROM) and a random access memory (RAM). The auxiliary storage unit 103 is a storage medium including a hard disk and a flash memory. In general, the auxiliary storage unit 103 stores a larger amount of data than the main storage unit 102. At least some of the constituents of the operation plan creation device 10 are realized by the auxiliary storage unit 103. For example, a process device setting DB 14 illustrated in FIG. 2 may be realized by the auxiliary storage unit 103. The communication unit 104 is constituted by a network card or a wireless communication module. At least a part of the constituents of the operation plan creation device 10 may be realized by the communication unit 104. The operation unit 105 includes a keyboard, a mouse, a touch panel, and a voice-input microphone. The output unit 106 includes a display and a printer. For example, the operation plan creation device 10 may display an operation plan or the like on the display.

The auxiliary storage unit 103 stores a program and data required for processes in advance. The program causes the computer 100 to perform the functional elements of the operation plan creation device 10. For example, the program is read by the processor 101 or the main storage unit 102. The program causes at least one of the processor 101, the main storage unit 102, the auxiliary storage unit 103, the communication unit 104, the operation unit 105, and the output unit 106 to operate. For example, the program performs reading and writing of data in the main storage unit 102 and the auxiliary storage unit 103.

An operation plan creation program 110 illustrated in FIG. 3 is for performing a method of creating an operation plan of the process device 3. The operation plan creation program 110 may be provided, for example, in a state in which it is recorded on a tangible recording medium such as a CD-ROM, a DVD-ROM, or a semiconductor memory. The operation plan creation program 110 may be provided as data signals via a communication network.

### <Operation Plan Creation Device>

A specific functional configuration of the operation plan creation device 10 will be described below with reference back to FIG. 2. The operation plan creation device 10 includes the communication unit 104, a prediction unit 11, and a simulation arithmetic unit 13. The operation plan creation device 10 includes the process device setting DB 14. Reference sign “101” in FIG. 2 schematically indicates that the prediction unit 11 and the simulation arithmetic unit 13 are realized by causing the processor 101 to execute a program.

An operation plan which is created by the operation plan creation device 10 includes at least a start time of an operational preparation required time period. The operation plan may include values acquired through calculation until the start time of the operational preparation required time period is determined. For example, the operation plan may include a total amount of production P, a constituent amount of production for each section, and power consumption pₘ.

The operation plan creation device 10 is connected to an external weather forecast service 201 via the Internet or a dedicated line. This connection is realized by the communication unit 104. The weather forecast service 201 periodically calculates weather data of one to 30 days in the future in an area including the latitude and longitude of the microgrid 1 using weather simulation of a supercomputer, numerical correction technology of an AI, or the like based on weather satellite data or regional observation data. The weather data includes, for example, temperature, humidity, a wind speed, a wind direction, a rainfall, a snowfall, a snow depth, a global solar radiation, and an amount of cloud. The operation plan creation device 10 periodically acquires weather forecast data based on a communication protocol such as a file transfer protocol (FTP) or a hypertext transfer protocol (HTTP) from the weather forecast service. The weather forecast data is acquired at various timing such as one time per day, four times per day, or 48 times per day (every 30 minutes).

### <Communication Unit>

The communication unit 104 acquires weather forecast data from the weather forecast service 201 via the Internet or a dedicated line.

### <Prediction Unit 11>

The prediction unit 11 includes a power generation predicting unit 111 and a renewable-energy surplus electric power calculating unit 112. The power generation predicting unit 111 predicts an amount of electric power generated by the photovoltaic power generation system 2 (an amount of PV electric power) based on the weather forecast data. Then, the renewable-energy surplus electric power calculating unit 112 calculates renewable-energy surplus electric power based on a predicted value of the amount of PV electric power. The renewable-energy surplus electric power calculating unit 112 outputs the calculated renewable-energy surplus electric power. In the following description, the renewable-energy surplus electric power is simply referred to as surplus electric power pₛ.

### <Power Generation Predicting Unit>

The power generation predicting unit 111 outputs a predicted value of an amount of PV electric power in a planned section using the acquired weather forecast data. The power generation predicting unit 111 calculates a predicted value of an amount of generated electric power, for example, using solar radiation and/or temperature in the weather forecast data.

The power generation predicting unit 111 is not limited to a prediction operation using the weather forecast data. For example, the power generation predicting unit 111 may predict an amount of PV electric power in the future using machine learning or statistical technology based on result values of a pyrheliometer and result values of the amount of PV electric power in the microgrid 1. The power generation predicting unit 111 may predict the amount of PV electric power from prediction results of cloud movement from an omnidirectional camera in the microgrid 1. The power generation predicting unit 111 may directly receive the predicted value of the amount of PV electric power from an external system via the Internet. The predicted value of the amount of PV electric power output from the power generation predicting unit 111 includes at least a predicted value in a planned section of an operation plan which will be described later.

### <Renewable-Energy Surplus Electric Power Calculating Unit>

The renewable-energy surplus electric power calculating unit 112 calculates surplus electric power pₛ from the predicted value of the amount of PV electric power acquired from the power generation predicting unit 111. In the first embodiment, there is no power load except for the process device 3. Accordingly, it is assumed that the surplus electric power pₛ is the same as the predicted value of the amount of PV electric power. In consideration of electric power consumed in facilities or devices in the microgrid 1 such as control devices, communication devices, lighting facilities, monitoring cameras, and air-conditioning facilities, the surplus electric power pₛ may be obtained by subtracting a fixed value from the predicted value of the amount of PV electric power. In this case, when the surplus electric power pₛ has a negative value, the surplus electric power pₛ is set to 0. The fixed value is an average value of a total amount of electric power consumed in the facilities and devices in the microgrid 1.

The renewable-energy surplus electric power calculating unit 112 may acquire the surplus electric power pₛ by calculating a predicted value of the demand for electric power and then subtracting the predicted value of the electric power consumers from the predicted value of the amount of PV electric power.

When the scale of the electric power consumers is not negligibly small and varies with time, demand of electric power needs to be predicted using any method similarly to the amount of electric power generated by photovoltaic power generation. However, in the first embodiment, it is assumed that demand of electric power in the electric power consumers is negligibly small. It is assumed that the surplus electric power pₛ is the same as the predicted value of the amount of PV electric power.

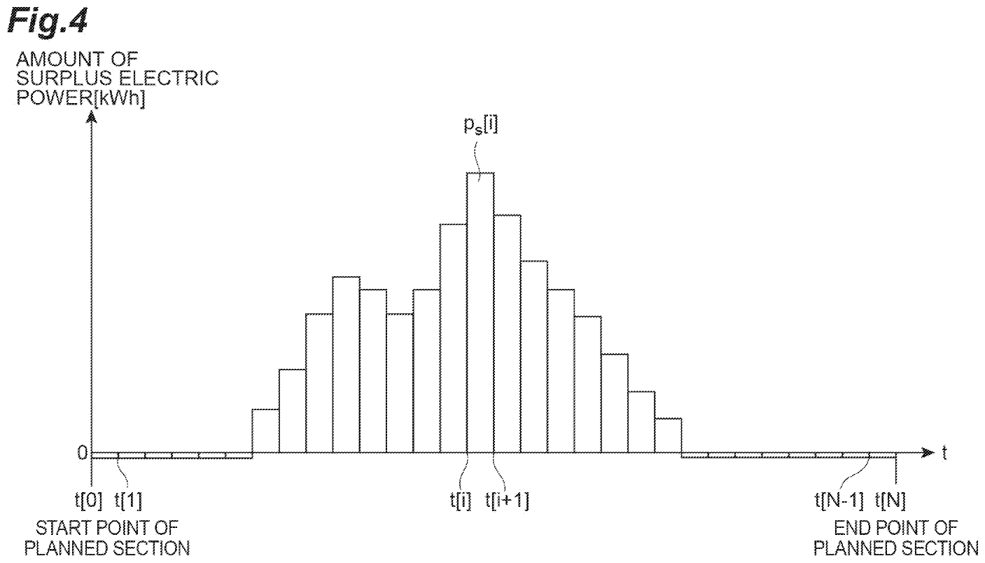

FIG. 4 is a conceptual diagram of the surplus electric power pₛ generated in a planned section. As illustrated in FIG. 4, a planned section is defined by a start point time t[0], an end point time t[N], and times t[i] (where i=1, 2, . . . , N−1) equally dividing the planned section to N parts. A length of a time interval (h) is, for example, 30 minutes or 1 hour. When the planned section is one day, N=48 is established by setting the length of the time interval (h) to 30 minutes, and N=24 is established by setting the length of the time interval (h) to 1 hour. The planned section may range from one day to three days or may be a period longer than three days, for example, one week.

In the following description, a period of from time t[i] to time t[i+1] is referred to as section [i]. The surplus electric power generated in section [i] is referred to as surplus electric power pₛ[i] (where i=0, 1, 2, . . . , N−1). Subscript “s” means surplus, and “p” means power. In FIG. 4, parts marked such that the surplus electric power pₛ[i] is negative are illustrated by lowering a bar chart for the purpose of emphasizing 0. The unit of the surplus electric power pₛ[i] is watt-hour [kWh]. The unit of surplus electric power pₛ[i] may be average wattage [kW] in section [i].

### <Process Device Setting DB>

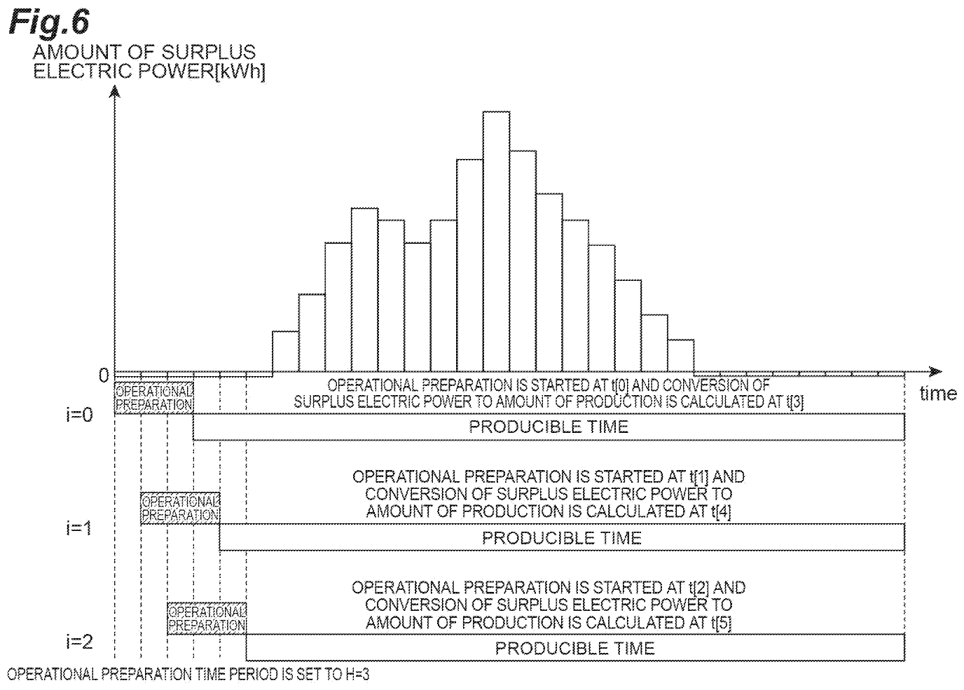

The process device setting DB 14 includes an operational preparation required time period which is a time period required for an operational preparation as a parameter. The operational preparation required time period is a time period required until the process device 3 switches from a non-producible state to a producible state after the operational preparation has been made. The operational preparation required time period is defined by H sections with one section as one unit (see FIG. 6). The planned section includes the operational preparation required time period and an operable time period.

### <Simulation Arithmetic Unit>

The simulation arithmetic unit 13 will be described below. The simulation arithmetic unit 13 (a processing unit) creates an operation plan by changing conditions based on various parameters in the process device setting DB 14 and the surplus electric power pₛ[i] and repeatedly performing simulation of operational preparation and production of the process device 3. The simulation arithmetic unit 13 includes a total production amount calculating unit 131 (a total evaluation quantity calculating unit), a total production amount determining unit 132 (a total evaluation quantity determining unit), a start time determining unit 133, and an operation plan output unit 134.

### <Total Production Amount Calculating Unit>

The total production amount calculating unit 131 calculates a total amount of production P. The total amount of production P is an example of a total evaluation value based on an amount of electric power consumed in the process device 3 to produce a product. Another example of the total evaluation value is a power consumption pₘ consumed in the process device 3 to produce a product. The total amount of production P is an amount of product that can be produced by the process device 3 up to the end point t[N] when it is assumed that the operational preparation has been made at time t[i]. The total amount of production P is calculated based on the surplus electric power pₛ[i] and the operational preparation required time period.

The total production amount calculating unit 131 performs calculating the total amount of production P which is an amount of product produced by the process device 3 based on the surplus electric power pₛ[i] which is a predicted value and the operational preparation required time period for each of a plurality of start time candidates based on the premise that the operational preparation is started at a predetermined startable time selected out of a plurality of startable times. This operation of the total production amount calculating unit 131 will be described below in more detail.

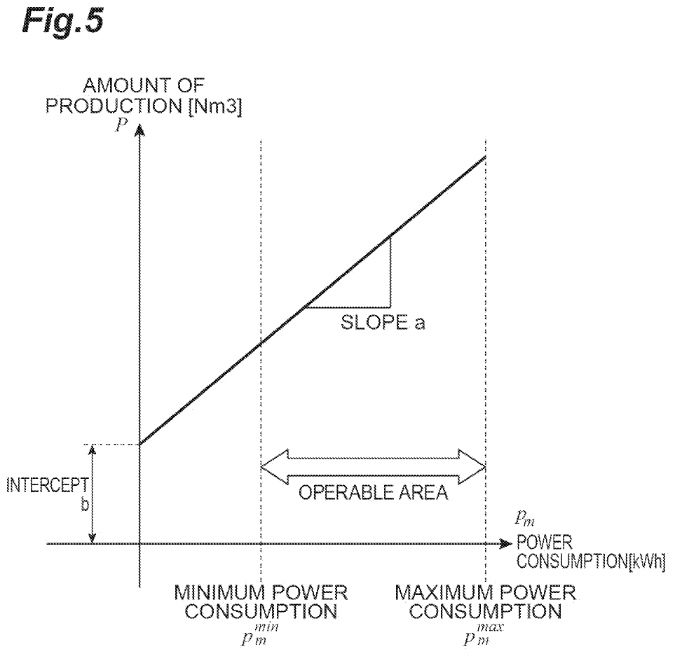

FIG. 5 is a diagram illustrating a relationship between a power consumption pₘ and an amount of production P[i] in the process device 3. The total production amount calculating unit 131 calculates the amount of production P[i] using the power consumption pₘ of the process device 3 determined based on the surplus electric power pₛ[i] and a linear equation (P=a×pₘ+b). A maximum power consumption pₘ^{max}, a minimum power consumption pₘ^{min}, and a slope a and an intercept b of the linear equation (P=a×pₘ+b) are parameters included in the process device setting DB 14.

The power consumption of the process device 3 includes a maximum power consumption pₘ^{max} which is an upper limit and a minimum power consumption pₘ^{min} which is a lower limit. The process device 3 can operate when the power consumption pₘ is between the maximum power consumption pₘ^{max} and the minimum power consumption pₘ^{min}. An area between the maximum power consumption pₘ^{max} and the minimum power consumption pₘ^{min} is referred to as an operable area. When the surplus electric power pₛ[i] is less than the minimum power consumption pₘ^{min}, the power consumption pₘ[i] is 0. In other words, when the surplus electric power pₛ[i] is below the operable area, the power consumption pₘ[i] is 0. The amount of production P[i] is 0.

For example, when a surplus electric power pₛ[j] in section [j] is given and pₛ[j]≥pₘ^{max} is satisfied, the power consumption pₘ[j] and the amount of production P[j] of the process device 3 in section [j] are as follows. A relationship between variable j and variable i is defined as j=i+H.

$${p}_{m} [ j ] = {p}_{m}^{m ax}$$

$$P [ j ] = a \times {p}_{m}^{ma x} + b$$

When a surplus electric power pₛ[j] in section [j] is given and pₛ[j]<pₘ^{min} is satisfied, the power consumption pₘ[j] and the amount of production P[j] of the process device 3 in section [j] are as follows.

pₘ[j]=0

P[j]=0

When a surplus electric power pₛ[j] in section [j] is given and the surplus electric power pₛ[j] in section [j] is different from the above description, the power consumption pₘ[j] and the amount of production P[j] of the process device 3 in section [j] are as follows.

$${p}_{m} [ j ] = {p}_{s} [ j ]$$

$$P [ j ] = a \times {p}_{s} [ j ] + b$$

A process of the total production amount calculating unit 131 will be described below with reference to FIG. 6. FIG. 6 is a conceptual diagram of simulation of operational preparation and production. Sign H in FIG. 6 indicates the number of steps of the operational preparation required time period of the process device 3. For example, when the time interval (h) is 30 minutes and the operational preparation required time period is 90 minutes, H=3 is set. The time interval required for the operational preparation required time period is set to three sections (H=3). In FIG. 6, a method of calculating a total amount of production when it is assumed that an operational preparation is started at each of startable times t[0], t[1], and t[2] is illustrated as a representative example.

When the operational preparation is started at startable time t[0], the total production amount calculating unit 131 makes the operational preparation from section [0] to section [2]. An operable time period is from section [3] to section [N−1]. The total production amount calculating unit 131 calculates a constituent amount of production of a product for each section of from section [3] to section [N−1]. Then, the total production amount calculating unit 131 calculates a total amount of production P which is a sum of the constituent amounts of production.

When the operational preparation is started at startable time t[1], the total production amount calculating unit 131 makes the operational preparation from section [1] to section [3]. An operable time period is from section [4] to section [N−1]. The total production amount calculating unit 131 calculates a constituent amount of production of a product for each section of from section [4] to section [N−1]. Then, the total production amount calculating unit 131 calculates a total amount of production P which is a sum of the constituent amounts of production.

When the operational preparation is started at startable time t[2], the total production amount calculating unit 131 makes the operational preparation from section [2] to section [4]. An operable time period is from section [5] to section [N−1]. The total production amount calculating unit 131 calculates a constituent amount of production of a product for each section of from section [5] to section [N−1]. Then, the total production amount calculating unit 131 calculates a total amount of production P which is a sum of the constituent amounts of production.

The total production amount calculating unit 131 calculates an operable time period when it is assumed that the operational preparation is started at each of startable times t[3], t[4], . . . , t[N−3] in the same way. Then, the total production amount calculating unit 131 calculates an amount of production of a product for each section included in the operable time period. Then, the total production amount calculating unit 131 calculates a total amount of production P which is a sum of the amounts of production of the product.

The total production amount calculating unit 131 extracts at least one total amount of production P indicating a maximum value as a maximum total amount of production Pₘₐₓ out of a plurality of total amounts of production P acquired for a plurality of startable times t[i]. The total production amount calculating unit 131 selects a startable time t corresponding to the at least one maximum total amount of production Pₘₐₓ as a first start time candidate which is a candidate for a time at which the operational preparation is to be started.

### <Total Production Amount Determining Unit>

The maximum total amount of production Pₘₐₓ is an estimated value of a maximum value of the total amount of production P when the process device 3 operates. When the maximum total amount of production Pₘₐₓ is less than a predetermined target of the amount of production, it is reasonably determined that the operational preparation is not to be started. Therefore, the maximum total amount of production Pₘₐₓ is compared with a threshold value stored in the process device setting DB 14. When the maximum total amount of production Pₘₐₓ is equal to or greater than the threshold value, it is reasonably determined that the operational preparation is to be started. When the maximum total amount of production Pₘₐₓ is not equal to or greater than the threshold value, it is determined that the operational preparation is not to be made.

The total production amount determining unit 132 determines whether it is reasonable to start the operational preparation at the first start time candidate. Specifically, the total production amount determining unit 132 selects at least one first start time candidate of which the maximum total amount of production Pₘₐₓ is equal to or greater than a threshold value as a second start time candidate out of the at least one first start time candidates by comparing the at least one maximum total amount of production Pₘₐₓ with the threshold value.

### <Start Time Determining Unit>

There is a plurality of cases which is determined as the maximum total amount of production Pₘₐₓ depending on generation patterns of the surplus electric power pₛ. In this case, a case of the latest start time candidate is employed as the operation plan. In other words, a case of the shortest operable time period is employed as the operation plan. This is because the selected case is considered to be a case in which the time period from completion of the operational preparation to production is shortest. The time period from completion of the operational preparation to production may be replaced with a time period in which the process device is on standby.

When a plurality of second start time candidates is selected by the total production amount determining unit 132, the start time determining unit 133 employs a latest second start time candidate out of the plurality of second start time candidates as a start time at which the operational preparation is to be started.

### <Operation Plan Output Unit>

The operation plan output unit 134 creates an operation plan including information of an operation start time t[i] at which the operational preparation is made, the amount of power pₘ consumed in the process device 3, the total amount of production P of a product to be produced, and at least one constituent amount of production of the product which is produced in each section.

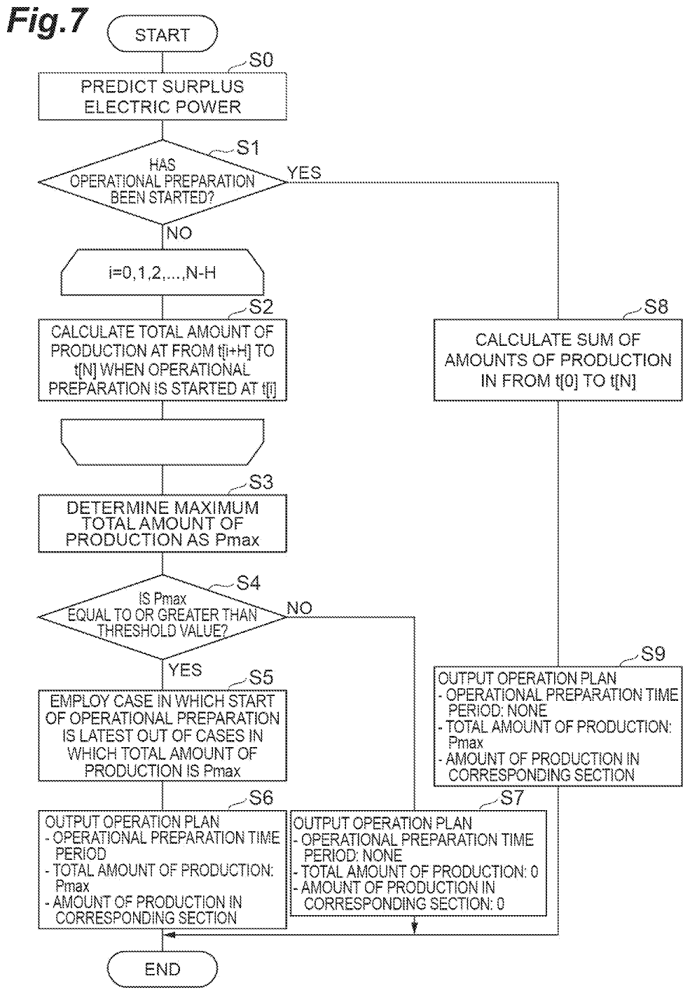

A process of creating an operation plan which is performed by the operation plan creation device 10 will be described below. FIG. 7 illustrates principal steps of an operation plan creation process which is performed by the operation plan creation device 10. The process flow illustrated in FIG. 7 may be periodically performed by the operation plan creation device 10 at a certain time (for example, 3:00 AM) of a day. The process flow illustrated in FIG. 7 may be periodically and automatically performed every hour. The process flow illustrated in FIG. 7 may be manually performed every hour. Manual performance means, for example, that a user of the operation plan creation device 10 operates the operation unit 105. The process flow illustrated in FIG. 7 may be performed at a timing at which weather forecast data is received. A start timing of the planned section is the current time. An end timing of the planned section comes after 24 hours.

First, a surplus electric power pₛ is predicted (S0). This operation is performed by the prediction unit 11. The operation of the prediction unit 11 is the same as described above and thus description thereof in this paragraph will be omitted.

Then, it is determined whether an operational preparation of the process device 3 has been already started (S1). This operation may be, for example, acquiring device operation information from the process device 3.

When time t[0] which is a start point of the planned section is later than a time point at which the operation plan is created, the state of the process device 3 at time t[0] is generally unclear. The state of the process device 3 indicates, for example, when the operational preparation has been completed and whether the process device 3 is operating. Accordingly, when time t[0] which is a start point of the planned section is later than a time point at which the operation plan is created and there is another operation plan of the process device 3, it is necessary to refer to the other operation plan.

When the operational preparation has been already started (S1: YES), a sum of constituent amounts of production (a total amount of production) in a period of from time t[0] to time t[N] is calculated (S8). This operation is performed by the total production amount calculating unit 131. The constituent amount of production in each section of from time t[0] to time t[N] and the total amount of production P which is a sum of the constituent amounts of production are output as an operation plan (S9). This operation is performed by the operation plan output unit 134.

When an operational preparation has not been performed (S1: NO), the total amount of production P is calculated (S2). This operation is performed by the total production amount calculating unit 131. The total production amount calculating unit 131 calculates the total amount of production P when the operational preparation has been started at time t[i] to the total amount of production P when the operational preparation has been started at time t[N−H].

Then, the total amount of production P of a maximum value is determined to be a maximum total amount of production Pₘₐₓ (S3). This operation may also be performed by the total production amount calculating unit 131.

Then, it is determined whether the maximum total amount of production Pₘₐₓ is equal to or greater than a threshold value (S4). This operation is performed by the total production amount determining unit 132. In this operation, it is determined whether at least one maximum total amount of production Pₘₐₓ is equal to or greater than the threshold value. As a result, the number of maximum total amounts of production Pₘₐₓ equal to or greater than the threshold value may be one. The number of maximum total amounts of production Pₘₐₓ equal to or greater than the threshold value may be two or more (S4: YES). On the other hand, the number of maximum total amounts of production Pₘₐₓ equal to or greater than the threshold value may be zero (S4: NO).

When there is a maximum total amount of production Pₘₐₓ equal to or greater than the threshold value (S4: YES), the start time determining unit 133 determines that it is reasonable to start the operational preparation at the first start time candidate. The first start time candidate is selected as a second start time candidate. Then, a time at which start of the operational preparation is latest out of the selected second start time candidates is employed (S5). This operation is performed by the start time determining unit 133. The total amount of production P at the employed operation start time and the constituent amount of production in each section are output as an operation plan (S6). This operation is performed by the operation plan output unit 134.

When the number of maximum total amounts of production Pₘₐₓ equal to or greater than the threshold value is zero (S4: NO), the operation plan output unit 134 outputs an operation plan including information indicating that the operational preparation has not been made, information indicating that the total amount of production P of a product is 0, and information indicating that the constituent amounts of production of the product in the sections are 0 (S7).

When an operation plan has been created, the operation plan creation device 10 may notify and/or advise an operator of information on the operation plan through display on a monitor, lighting of a lamp, an alarm sound, a mail, or the like. Based on the operation plan, the operation plan creation device 10 may automatically operate the process device 3 at the corresponding time. When a function of creating an operation plan and a function of performing control based on an operation plan are provided, the operation plan creation device 10 is an energy management (“EMS”) system for the microgrid 1. The operation plan creation device 10 may perform only operation of the process device 3. The usage of an operation plan is not limited to operating the devices. An operation plan may be used for a tender to a power market or application for self-consignment of electric power. An operation plan may be used for determination of instructions or responses of a demand response for avoiding poorness in electric power, or the like. The operation plan may be transmitted as a schedule of an amount of production to another host system (not illustrated) for managing products.

### Effects

In the following description, problems in the related art will be first mentioned and thus effects achieved by the operation plan creation device 10 will be described.

When an operation plan for a process device which has difficulty instantaneously starting its operation and which is exemplified as a methanation device is created, there are two problems to be solved from the constraints that it is difficult to instantaneously start its operation. The first problem is a problem of whether an operational preparation of the process device is to be started. The second problem is a problem of at what timing the operational preparation is to be started when the operational preparation is started. In the first problem, it is important to predict an amount of production which can be produced when the device operates. When an expected amount of production is small, energy required for raising the temperature is useless and thus it can be determined that it is reasonable not to start the operational preparation. In the second problem, a new technique in comprehensive consideration of a time period in which a surplus electric power pₛ is generated and a time in which the device is prepared is needed for determining the start time.

Several related arts described below do not provide solutions to such problems.

For example, the technique disclosed in Japanese Unexamined Patent Publication No. 2020-54085 is based on the premise that the hydrogen production device can start production of hydrogen at any time after the capacity of the storage battery has reached an upper limit. Accordingly, it is difficult to apply detail of the technique disclosed in Japanese Unexamined Patent Publication No. 2020-54085 to the methanation device. It is conceivable that the process device be always in a producible state by always maintaining the process device at a desired temperature. However, this causes useless energy loss, which is not preferable.

For example, in the technique disclosed in PCT International Publication No. WO 2020/121436, the device operates in a preparation time period before a supply and demand adjustment time period of a demand response. However, this operation can be performed because the supply and demand adjustment time period is known. The operation plan creation device 10 according to the first embodiment is applied to production using surplus electric power of renewable energy. That is, it is known beforehand when surplus electric power is generated. Accordingly, the premise in the technique disclosed in PCT International Publication No. WO 2020/121436 is different from the premise of the operation plan creation device 10 according to the first embodiment.

For example, the technique disclosed in Japanese Unexamined Patent Publication No. 2022-020978 has the same problem as the technique disclosed in Japanese Unexamined Patent Publication No. 2020-54085.

In the technique disclosed in Japanese Unexamined Patent Publication No. 2021-164178, increasing/decreasing of the power consumption in the load device is performed using a predicted value of an amount of electric power generated using renewable energy or a storage battery residual. However, the supposed load is a light or an air conditioner as described in Paragraph 0130 in the technique disclosed in Japanese Unexamined Patent Publication No. 2021-164178. These devices are devices that can instantaneously consume electric power. In the technique disclosed in Japanese Unexamined Patent Publication No. 2021-164178, it is not assumed that a device requiring a preparation time to operate is controlled unlike the operation plan creation device 10 according to the first embodiment.

For example, in the technique disclosed in Japanese Patent No. 6189448, an amount of charging/discharging electric power of a storage battery, an amount of electric power consumed in a hydrogen production device, and an amount of electric power generated in a fuel cell are calculated based on a predicted value of an amount of electric power generated using renewable energy and a predicted value of electric power consumers. However, in the specification of Japanese Patent No. 6189448, a case in which a preparation time is required for a hydrogen production device is not described. Accordingly, there is room for improvement in the technique disclosed in Japanese Patent No. 6189448.

For example, when the technique disclosed in Japanese Unexamined Patent Publication No. 2022-25398 is applied to the operation plan creation device 10 according to the first embodiment without any change, an expected amount of production of the process device is not known. In the technique disclosed in Japanese Unexamined Patent Publication No. 2022-25398, a time at which an operational preparation is to be started cannot be known.

For example, in the technique disclosed in Japanese Patent No. 7008297, a preheating time and/or a precooling time of a hydrogen storage facility is determined. However, as described in the specification of Japanese Patent No. 7008297, an operation time period for production of hydrogen is first calculated, and then a preheating time and/or a precooling time is counted back from the operation time period for production and calculated. When calculation is performed in this order, it may be difficult to replenish electric power required for preheating and/or precooling with surplus electric power. There is a likelihood that a non-executable operation plan will be created depending on a relationship among the current time, the operation time period, and the preheating and precooling time. For example, immediately after the operation time has reached the current time, preheating and/or precooling may not be in time.

The operation plan creation device 10 and the operation plan creation method according to the first embodiment solve the problems in the related arts by employing the following configurations.

The operation plan creation device 10 according to the first embodiment creates an operation plan for a device that is able to switch from a non-producible state in which a product is not acquired even with inputting of electric power to a producible state in which a product is acquired with inputting of electric power by making an operational preparation. The operation plan creation device 10 includes the prediction unit 11 configured to acquire a predicted value of an amount of electric power which is able to be supplied to the process device 3 and which includes electric power originating from renewable energy and the simulation arithmetic unit 13 configured to create the operation plan based on the predicted value and an operational preparation required time period indicating a required time period for the operational preparation.

The operation plan creation device 10 creates an operation plan based on the predicted value of electric power which is able to be supplied to the process device 3 and the operational preparation required time period indicating a required time period for the operational preparation.

Accordingly, since the operational preparation required time period is reflected in the acquired operation plan, it is possible to curb creation of an operation plan which is not executable.

In other words, for the process device 3 requiring a preparation time period until its operation starts such as a methanation device, the operation plan creation device 10 according to the first embodiment calculates an expected amount of production which can be produced when the process device 3 operates based on the predicted value of electric power generated using renewable energy and the operational preparation required time period. The operation plan creation device 10 determines whether the operational preparation of the process device 3 is to be started when the expected amount of production is greater than a set value.

The operation plan creation device 10 according to the first embodiment can create an economical and reasonable operation plan of the process device 3 in consideration of trade-off between energy of the surplus electric power pₛ and energy required for the operational preparation. The operation plan creation device 10 creates the operation plan in consideration of a required time period required for the operational preparation of the process device 3. As a result, it is possible to create an operation plan which is executable.

The operation plan includes a plurality of startable time candidates which are able to be selected as a time at which the operational preparation is started. The simulation arithmetic unit 13 includes the total production amount calculating unit 131. The total production amount calculating unit 131 performs: calculating a total amount of production P based on a power consumption pₘ consumed in the process device 3 to produce the product based on the predicted value and the operational preparation required time period based on the premise that the operational preparation is started at a startable time candidate selected out of the plurality of startable time candidates for each of the plurality of startable time candidates; extracting at least one total amount of production P indicating a maximum value as a maximum total amount of production Pₘₐₓ out of a plurality of total amounts of production P acquired for each of the plurality of startable time candidates; and selecting the startable time candidate corresponding to the at least one maximum total amount of production Pₘₐₓ as a first candidate which is a candidate for a time at which the operational preparation is started. With this configuration, it is possible to determine a time at which the operational preparation is started based on a total amount of production P.

The simulation arithmetic unit 13 further includes the total production amount determining unit 132. The total production amount determining unit 132 is configured to select at least one startable time candidate in which the maximum total amount of production is equal to or greater than a threshold value as a second candidate out of the at least one first candidate by comparing the at least one maximum total amount of production with the threshold value. With this configuration, it is possible to determine a time at which the operational preparation is started based on the total amount of production P.

The simulation arithmetic unit 13 further includes the start time determining unit 133. The start time determining unit 133 is configured to employ a latest time out of the second candidates as a start time at which the operational preparation is started when a plurality of the second candidates is selected by the total production amount determining unit 132. With this configuration, it is possible to determine a time at which the operational preparation is started based on a total amount of production.

The simulation arithmetic unit 13 acquires the predicted value by predicting electric power output from a photovoltaic power generation system 2. With this configuration, it is possible to obtain an operation plan for a device that operates with electric power supplied from the photovoltaic power generation system 2.

The total evaluation quantity is a total amount of production P of the product which is produced by the process device 3 and calculated based on the power consumption pₘ. With this configuration, it is possible to perform evaluation based on a total amount of production P of the product.

The total evaluation quantity is a total amount of consumed electric power which is a sum of the power consumption pₘ. With this configuration, it is possible to perform evaluation based on the power consumption pₘ required for producing the product. Values obtained by multiplying an appropriate coefficient by the total amount of production or the total amount of consumed electric power may be adopted to calculate the total amount of production or the total amount of consumed electric power. An example of the coefficient is a forgetting coefficient.

### Second Embodiment

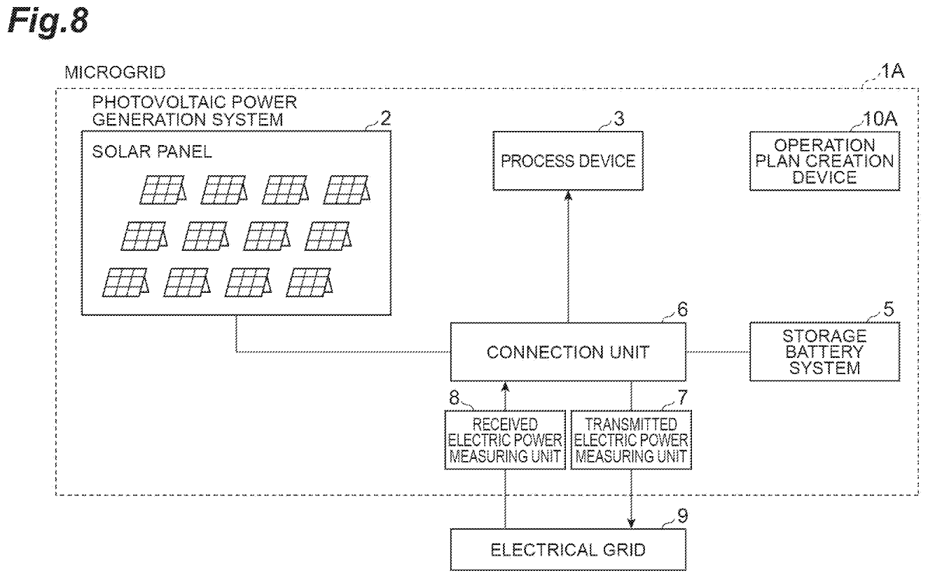

An operation plan creation device 10A according to a second embodiment illustrated in FIG. 8 will be described below in detail. FIG. 8 illustrates a microgrid 1A to which the operation plan creation device 10A according to the second embodiment is applied. The microgrid 1A includes the operation plan creation device 10A instead of the operation plan creation device 10. The microgrid 1A further includes a storage battery system 5 (an energy storage device).

The storage battery system 5 is a secondary battery. Examples of the secondary battery include a general secondary battery, a liquid-circulating secondary battery, a mechanical-charge storage battery, a high-temperature operating storage battery, and an electron-trap storage battery.

Examples of the general secondary battery include a lead storage battery, a lithium-ion secondary battery, a solid-state battery, a nickel-hydrogen storage battery, a nickel-cadmium storage battery, a nickel-iron storage battery (an Edison battery), a nickel-zinc storage battery, a zinc-silver oxide storage battery, and a cobalt-titanium-lithium secondary battery. Examples of the liquid-circulating secondary battery include a redox-flow battery, a zinc-chlorine battery, and a zinc-bromide battery. Examples of the mechanical-charge storage battery include an aluminum-air battery, an air-zinc battery, and an air-iron battery. Examples of the high-temperature operating storage battery include a sodium-sulfur battery (an NAS battery) and a lithium-iron-sulfide battery. An example of the electron-trap storage battery is a semiconductor secondary battery.

A storage battery (a secondary battery) is a generic name of devices that can be charged and/or discharged with electric power. The storage battery system 5 is defined to include a storage battery PCS converting DC electric power to AC electric power or a storage battery residual monitoring device in the storage battery system 5. The storage battery may be replaced with an energy storage device such as a capacitor or a flywheel having the same function, a compressed air energy storage (CAES) facility, a pumped power generation facility, or a heat-storage power generation facility temporarily storing electricity as heat and reconverting heat to electricity according to necessity.

When an operation plan of the process device 3 is created, the operation plan creation device 10A according to the second embodiment creates the operation plan of the process device 3 in consideration of charging electric power and discharging electric power of the storage battery system 5. Specifically, the operation plan creation device 10A according to the second embodiment creates an operation plan using mathematical programming. The hardware configuration of the operation plan creation device 10A is the same as the hardware configuration of the operation plan creation device 10. Accordingly, detailed description of the hardware configuration of the operation plan creation device 10A will be omitted.

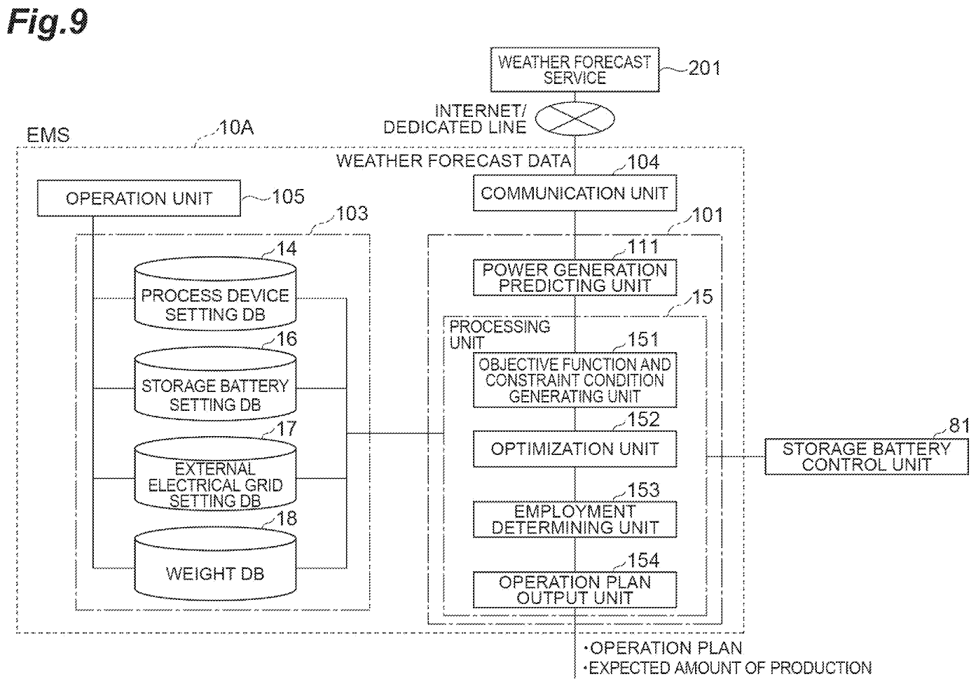

FIG. 9 illustrates a functional configuration of the operation plan creation device 10A. As only functions intended by the operation plan creation device 10 according to the first embodiment are illustrated, only functions (an operation plan creating function) intended by the operation plan creation device 10A according to the second embodiment are illustrated in FIG. 2.

### <Operation Plan Creation Device>

A specific functional configuration of the operation plan creation device 10A will be described below. The operation plan creation device 10A includes a communication unit 104, a power generation predicting unit 111, a processing unit 15, and an operation unit 105. The operation plan creation device 10A includes a process device setting DB 14, a storage battery setting DB 16, an external grid setting DB 17, and a weight DB 18. The storage battery system 5 includes a storage battery control unit 81. The storage battery control unit 81 includes information on a state of charge of a storage battery in a planned section. Reference sign “101” in FIG. 9 schematically indicates that the power generation predicting unit 111 and the processing unit 15 are realized by causing the processor 101 to execute a program. Reference sign “103” in FIG. 9 schematically indicates that the process device setting DB 14, the storage battery setting DB 16, the external grid setting DB 17, and the weight DB 18 are realized by the auxiliary storage unit 103.

The processing unit 15 creates an operation plan based on a predicted value of an amount of PV electric power predicted by the power generation predicting unit 111, an operational preparation required time period, and information on a state of charge acquired from the storage battery control unit 81. The processing unit 15 includes an objective function and constraint condition generating unit 151 (a generation unit), an optimization unit 152 (an arithmetic unit), an employment determining unit 153, and an operation plan output unit 154.

The power generation predicting unit 111 is the same as in the first embodiment and thus detailed description thereof will be omitted.

The objective function and constraint condition generating unit 151 collects parameters required for mathematical programming from the process device setting DB 14, the storage battery setting DB 16, the external grid setting DB 17, and the weight DB 18 according to necessity. The objective function and constraint condition generating unit 151 may acquire necessary information from the storage battery control unit 81 according to necessity. For example, the objective function and constraint condition generating unit 151 acquires a storage battery residual at a plan start point time (the current time) from the storage battery control unit 81.

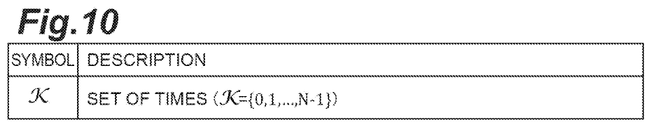

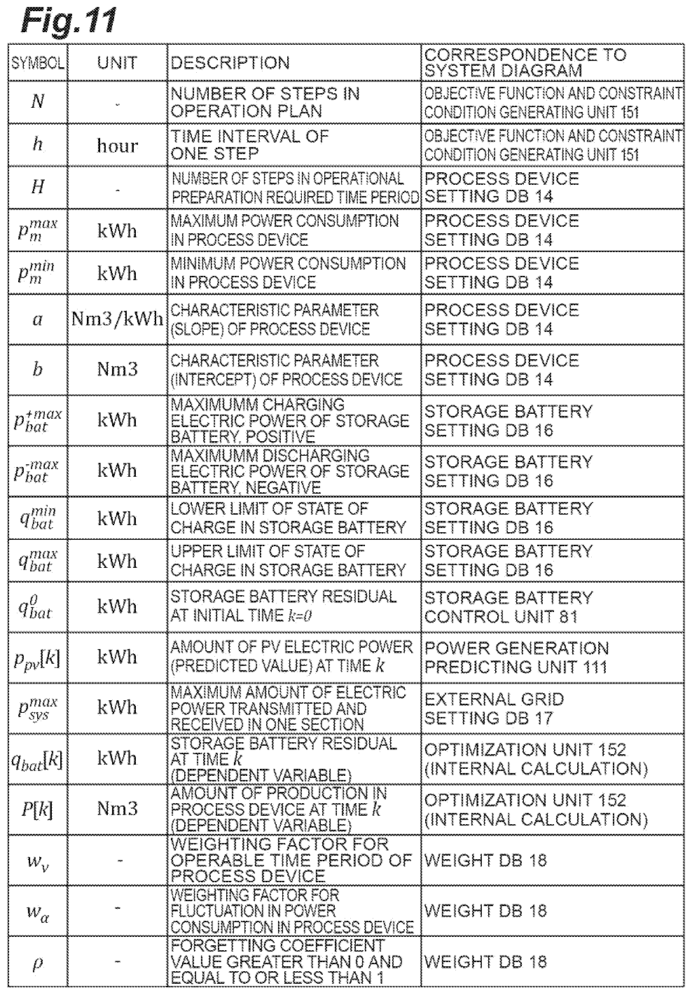

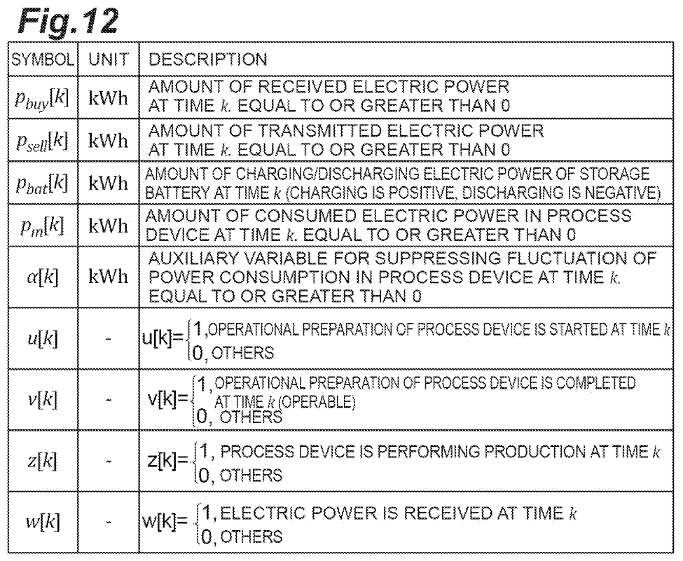

The objective function and constraint condition generating unit 151 formulates an objective function as a mixed integer programming problem (PG). Definitions of symbols used in a minimization problem are illustrated in the table of FIG. 10, the table of FIG. 11, and the table of FIG. 12. In the table of FIG. 11, from what unit each parameter is to be acquired is also described.

The mixed integer programming problem (PG) is described below.

$$\begin{matrix}[ Math . 1 ] & \\ ( PG ) maximize ( {\sum }_{k ∈ 𝒦} {ρ}^{k} P [ k ] - {w}_{v} h {\sum }_{k ∈ 𝒦} v [ k ] - {w}_{α} {\sum }_{k ∈ 𝒦} α [ k ] ) & ( 1 )\end{matrix}$$

$$subj . to$$

$${p}_{pv} [ k ] + {p}_{buy} [ k ] = {p}_{m} [ k ] + {p}_{sell} [ k ] + {p}_{b a t} [ k ] , k ∈ 𝒦 , \qquad ( 2 )$$

$$0 \leq {p}_{buy} [ k ] \leq {p}_{sys}^{ma x} w [ k ] , k ∈ 𝒦 , \qquad ( 3 )$$

$$0 \leq {p}_{sell} [ k ] \leq {p}_{sys}^{ma x} ( 1 - w [ k ] ) , k ∈ 𝒦 , \qquad ( 4 )$$

$${p}_{bat}^{- ma x} \leq {p}_{bat} [ k ] \leq {p}_{bat}^{+ ma x} , k ∈ 𝒦 , \qquad ( 5 )$$

$${q}_{bat}^{m i n} \leq {q}_{bat} [ k ] \leq {q}_{bat}^{ma x} , k ∈ 𝒦 , \qquad ( 6 )$$

$${p}_{m}^{m i n} z [ k ] \leq {p}_{m} [ k ] \leq {p}_{m}^{ma x} z [ k ] , k ∈ 𝒦 , \qquad ( 7 )$$

$${p}_{bat} [ k ] \leq {p}_{bat}^{+ ma x} ( 1 - w [ k ] ) , k ∈ 𝒦 , \qquad ( 8 )$$

$${p}_{m} [ k ] \leq {p}_{m}^{ma x} ( 1 - w [ k ] ) , k ∈ 𝒦 , \qquad ( 9 )$$

$$v [ k ] = 0 , k ∈ \{ 0 , 1 , … , H - 1 \} , \qquad ( 10 )$$

$$v [ k ] = {\sum }_{s = 0}^{t - H} u [ s ] , k ∈ \{ H , … , N \} , \qquad ( 11 )$$

$$z [ k ] \leq v [ k ] , k ∈ 𝒦 , \qquad ( 12 )$$

$$- α [ k ] \leq {p}_{m} [ k ] - {p}_{m} [ k - 1 ] \leq α [ k ] , k ∈ 𝒦 \backslash \{ 0 \} \qquad ( 13 )$$

$$such that$$

$$P [ k ] = α \times {p}_{m} [ k ] + b \times z [ k ] , \qquad ( 14 )$$

$${q}_{bat} [ k ] = {q}_{bat}^{0} + {\sum }_{s = 0}^{k} {p}_{bat} [ s ] . \qquad ( 15 )$$

Meanings of Expressions (1) to (15) are as follows.

Expression (1) means that an amount of production of a product is maximized. The first term of Expression (1) is an amount of production in which a forgetting coefficient is reflected. The first term of Expression (1) means that priority is given to an amount of production in the near future than an amount of production in the far future. When ρ=1, the value of the first term of Expression (1) matches the total amount of production P. The second term of Expression (1) is a term for shortening an operable time period. The second term of Expression (1) means that an operational preparation start time is preferably delayed as late as possible if the amount of production is the same. The third term of Expression (1) means that fluctuation of the power consumption of the process device 3 is minimized.

The reason for use of the forgetting coefficient is that the process device 3 is intended to produce a product with higher reliability. In the second embodiment, a predicted value of the photovoltaic power generation system 2 is used. The predicted value has higher uncertainty in the farther future. The predicted value has a higher likelihood of production as scheduled in the nearer future. Therefore, the forgetting coefficient is introduced to give a higher evaluation value to an amount of production in the near future than an amount of production in the far future. In the second embodiment, maximization of an amount of production is used as the objective function, but the present disclosure is not limited thereto. The objective function may be minimization in manufacturing cost or maximization in balance. In this case, information of a power-selling unit price, a power-purchase unit price, and a unit price of a product of the process device is additionally required.

Expression (2) means that electric power demand and electric power supply match at any time point in an operation period.

Expression (3) means that an amount of received electric power is equal to or less than a maximum amount of electric power.

Expression (4) means that an amount of transmitted electric power is equal to or less than a maximum amount of electric power.

Expression (5) means that an amount of charging/discharging electric power of a storage battery is in a predetermined range.

Expression (6) means that a state of charge of a storage battery is located between a predetermined upper limit and a predetermined lower limit.

Expression (7) means that the power consumption when the process device 3 is operating is in a predetermined range and the power consumption when the process device 3 is not operating is zero.

Expression (8) means that a storage battery is not charged when electric power is sold. Expression (8) means that the storage battery is charged with electric power of the photovoltaic power generation system 2.

Expression (9) means that a product is not produced when electric power is sold. Expression (9) means that a product is produced using electric power of the photovoltaic power generation system 2.

Expression (10) means that the process device 3 cannot operate in the corresponding period.

Expression (11) means that the process device 3 can operate in H steps after an operational preparation has been started.

Expression (12) means that a product is produced only when the process device 3 can operate.

Expression (13) means constraints on fluctuation of a power consumption of the process device 3.

Expression (14) means a relationship between a power consumption and an amount of production of a product in the process device 3.

Expression (15) means a relationship between an amount of charging/discharging electric power and a state of charge of a storage battery.

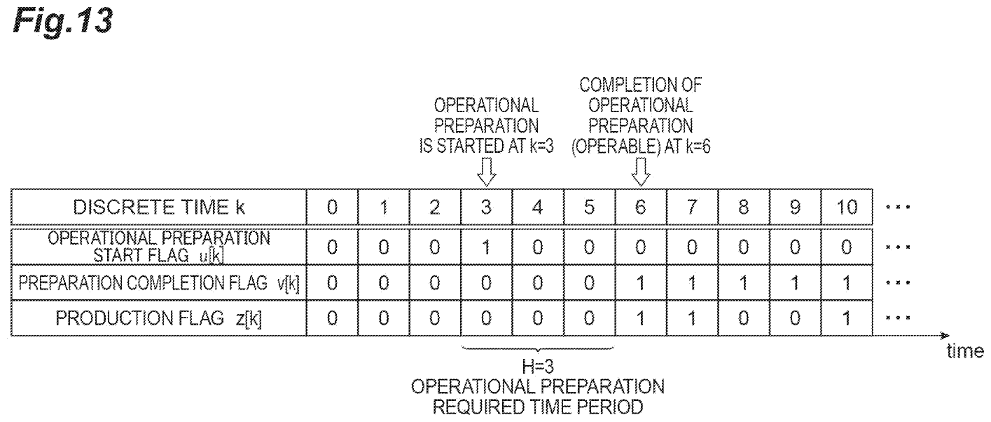

FIG. 13 is a diagram schematically illustrating flags u[k], v[k], and z[k] shown in the table of FIG. 12. In FIG. 13, “k” denotes a discrete time. For example, when H=3 is set and an operational preparation flag u[k] is 1 at k=3, 3+H=6 is established, operational preparation of the process device 3 has been completed at k=6, and a product is producible. When the operational preparation of the process device 3 has been completed (preparation completion flag v[k]=1), there may be a time period in which production is not performed (production flag z[k]=0). In FIG. 13, production is not performed at time k=8 and 9 (production flag z[k]=0). In description of the second embodiment, stop is not considered for the purpose of convenience. However, the aforementioned problem can be easily expanded to consideration of stop in the form of a stop preparation start flag.

When the optimization unit 152 acquires a solution to the mixed integer programming problem (PG) created by the objective function and constraint condition generating unit 151, decision variables (see the table of FIG. 12) are confirmed. Since the mixed integer programming problem (PG) is formulated, a solution thereto can be easily acquired, for example, using an optimization solver in the market. A dependent variable P[k] can be calculated from each decision variable. An estimated value of the total amount of production P is acquired from the sum of P[k]. Estimation of the total amount of production P may be performed by the optimization unit 152.

The operation plan output from the optimization unit 152 does not include determination from a viewpoint of whether the total amount of production P is greater or less than a threshold value. On the other hand, as determined in the first embodiment, when the total amount of production P is less than the threshold value, the operational preparation should not be started. In the operation plan output from the optimization unit 152, the total amount of production P may be greater than the threshold value or the total amount of production P may be less than the threshold value.

By evaluating whether the total amount of production P is greater or less than a threshold value, it is determined whether the operation plan output from the optimization unit 152 can be employed. This determination is performed by the employment determining unit 153.

The operation plan output unit 154 outputs the operation plan.

The operation of the operation plan output unit 154 is the same as the operation plan output unit 134 in the first embodiment and thus detailed description thereof will be omitted.

Determination of whether an operational preparation is to be started may be performed in the mixed integer programming problem (PG). In this case, a constraint condition of “(total amount of production)≤(threshold value)” is added to the mixed integer programming problem (PG). In this case, when no solution is calculated by the optimization unit 152, it is construed that the operational preparation is not to be started. However, there is also a likelihood that the reason of no solution is based on a problem other than the total amount of production P. An example of the reason of no solution is a bug in a program. Accordingly, as in the second embodiment, it is preferable that determination of whether an operational preparation is to be started using the total amount of production P be performed through a process other than an optimization calculation process in view of operation.

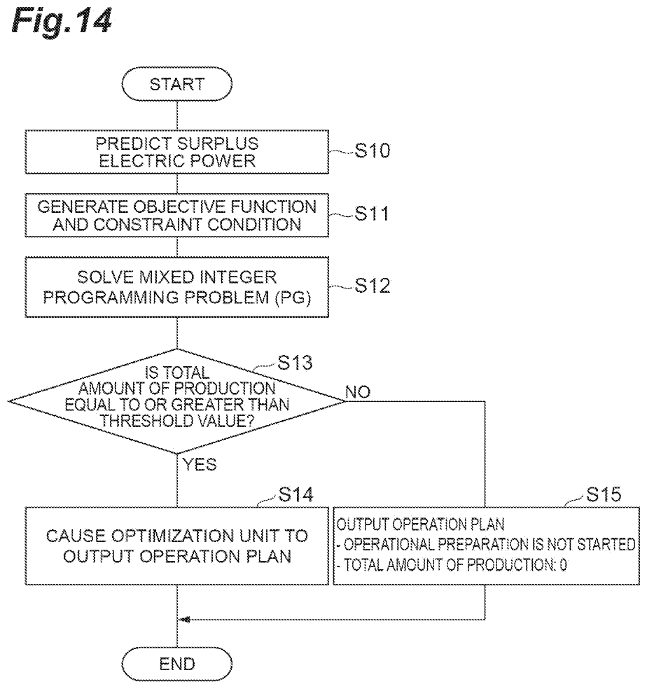

An operation plan creating process which is performed by the operation plan creation device 10A will be described below. FIG. 14 is a flowchart illustrating principal steps of the operation plan creation process which is performed by the operation plan creation device 10A.

The flowchart illustrated in FIG. 14 is performed at the same timing as performed by the operation plan creation device 10 according to the first embodiment.

The following description is based on the premise that an operational preparation is not started at a plan start point time (k=0). More generally, this can be expanded to a case in which an operational preparation is made at an arbitrary time point. In this case, an operational preparation completion variable (see Expression (16)) can be expanded to a minus time and initial conditions can be given thereto. For example, when an operational preparation is started at time −H, conditions indicated by Expression (17) are set. By replacing the start time of the summation of Expression (11) with Expression (18) instead of 0, Expression (19) is obtained. Expression (19) means that the operational preparation has been completed at the plan start point time. In this case, since Expression (11) can be calculated from k=0, Expression (10) is deleted.

$$\begin{matrix}[ Math . 2 ] & \\ u [ k ] & ( 16 )\end{matrix}$$

$$u [ - H ] = 1 , u [ - H + 1 ] = u [ - 2 ] = u [ - 1 ] = 0 \qquad ( 17 )$$

$$- H \qquad ( 18 )$$

$$v [ 0 ] = {\sum }_{s = - H}^{- H} u [ s ] = u [ - H ] = 1 \qquad ( 19 )$$

First, a surplus electric power pₛ is predicted (S10). This operation is the same as in the first embodiment and thus detailed description thereof will be omitted.

Then, an objective function and a constraint condition are generated (S11). This operation is performed by the objective function and constraint condition generating unit 151.

Then, a mixed integer programming problem (PG) represented by the objective function and the constraint condition is solved (S12). This operation is performed by the optimization unit 152. The total amount of production P is acquired additionally using the mixed integer programming problem (PG).

Then, it is determined whether the total amount of production P is equal to or greater than a threshold value (S13). This operation is performed by the employment determining unit 153.

When the total amount of production P is equal to or greater than the threshold value (S13: YES), an operation plan output from the optimization unit 152 is output (S14). This operation is performed by the operation plan output unit 154.

When the total amount of production P is not equal to or greater than the threshold value (S13: NO), information indicating that the operation plan output from the optimization unit 152 is not employed, that the operational preparation is not made, and that the total amount of production P of a product is 0 is output as the operation plan (S15). This operation is also performed by the operation plan output unit 154.

### Effects

In the operation plan creation device 10A according to the second embodiment, the processing unit 15 includes: the objective function and constraint condition generating unit 151 configured to prepare a mixed integer programming problem (PG) including a term indicating an amount of production of a product in the process device 3 at a predetermined time and a term indicating whether the process device 3 is able to produce the product with reception of electric power; the optimization unit 152 configured to acquire a candidate for the operation plan by solving the mixed integer programming problem (PG); and the employment determining unit 153 configured to employ the candidate for the operation plan as the operation plan when the total amount of production of the product acquired based on the operation plan is equal to or greater than a threshold value. With this configuration, it is possible to create an operation plan in consideration of the operational preparation required time period using mathematical programming.

### Calculation Example

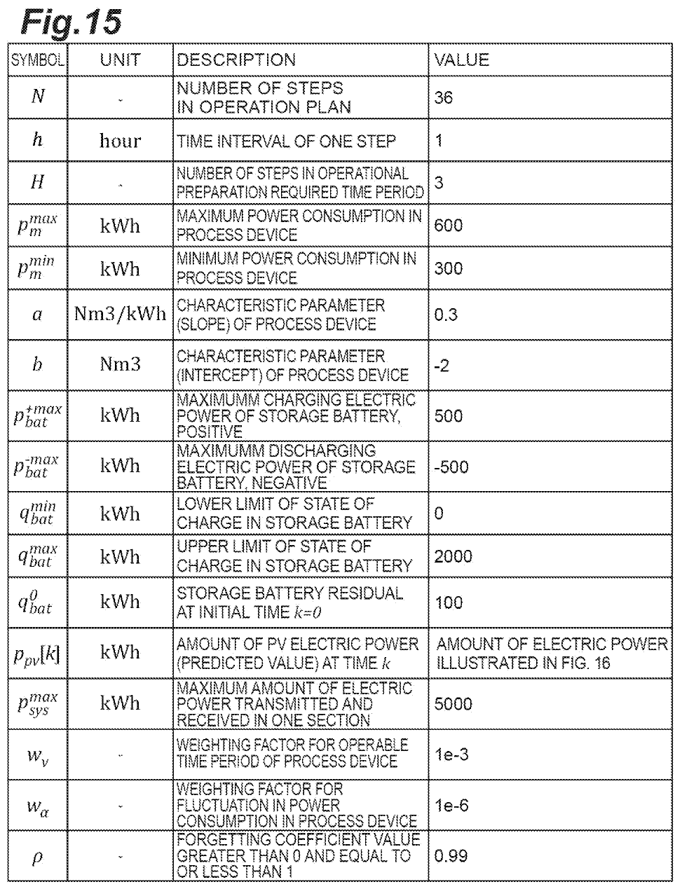

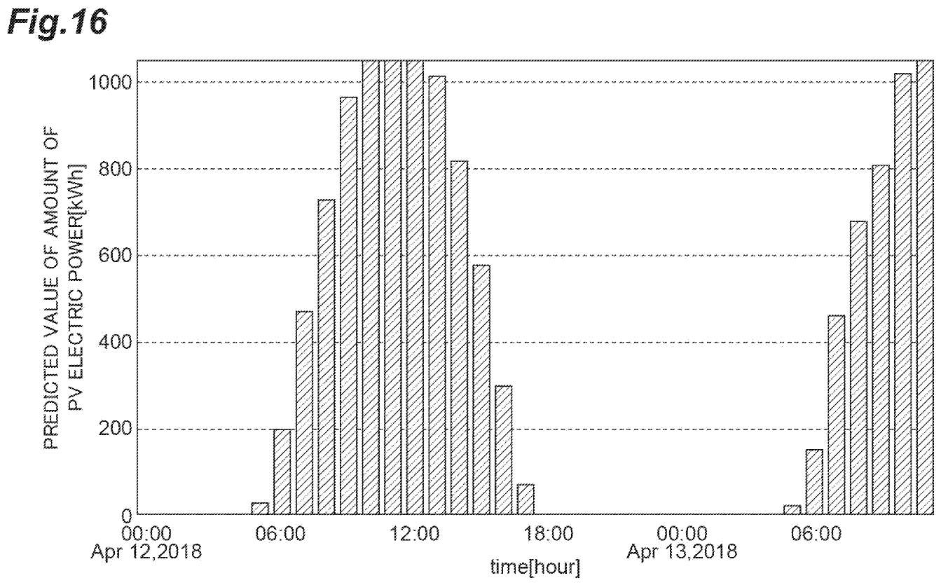

An optimization calculation example will be described below. Parameters which are used are illustrated in the table of FIG. 15. FIG. 16 illustrates predicted values of an amount of electric power generated by photovoltaic power generation which are used in the calculation example. An operation plan includes 36 steps with an interval of 1 hour from Apr. 12, 2018. That is, the operation plan is a plan of a day and a half. The operational preparation required time period is set to 3 hours.

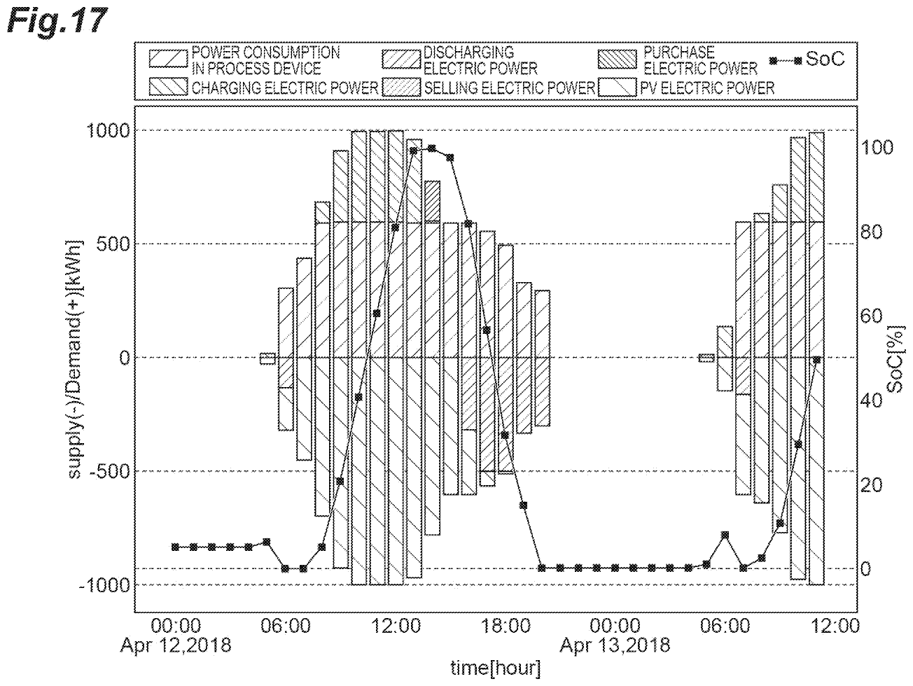

Optimization results are illustrated in FIGS. 17, 18, and 19. FIG. 17 illustrates changes of an electric power balance and an amount of stored electric power in the microgrid. In FIG. 17, a positive value of a cumulative bar chart indicates movement on a power consumption side. In FIG. 17, a negative value of the cumulative bar chart indicates movement on a power generation side and corresponds to the left coordinate axis. Since the bar chart is vertically symmetric, it can be seen that a balance between power generation and power consumption is taken. A line graph indicates a change of a SoC [%] and corresponds to the right coordinate axis. Referring to FIG. 17, it can be seen that the storage battery system 5 is charged well and electric power is consumed in the process device 3 at the time of starting of the photovoltaic power generation system 2 and a final surplus electric power pₛ (equivalent to sold electric power in the calculation example) is minimized. Power selling occurs only at 14:00 on April 12 in FIG. 17. This is because the state of charge of the storage battery system 5 reaches a limit (SoC 100%) and the power consumption in the process device 3 is maximized (500 kWh). After sunset, it can be seen that a product is produced by the process device 3 using electric power stored in the storage battery system 5 and the amount of production is maximized.

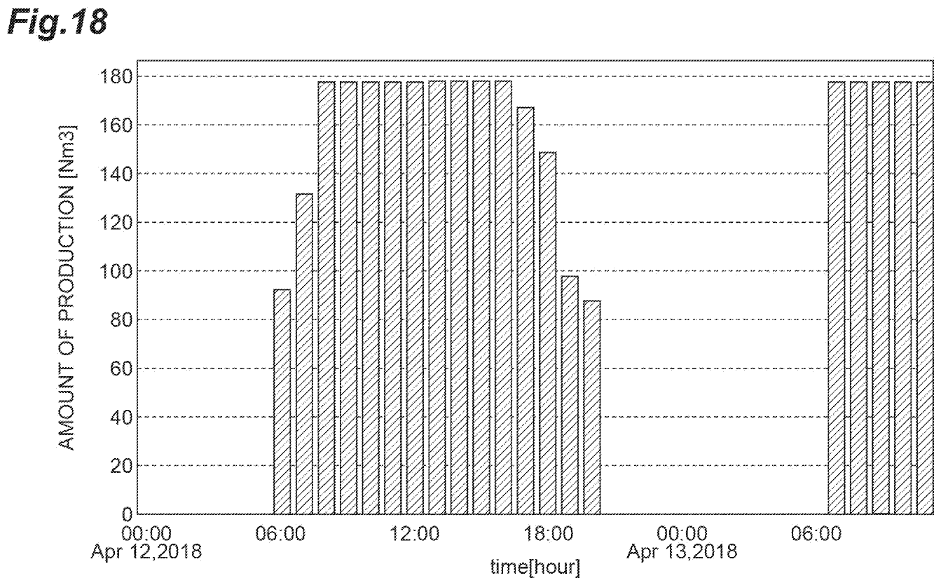

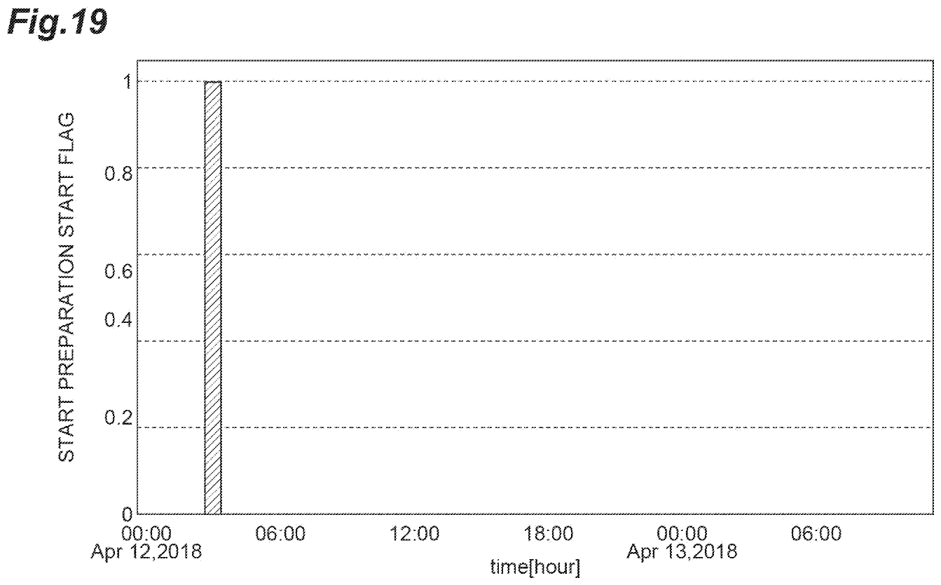

FIG. 18 illustrates a change of an amount of production in the process device 3. FIG. 19 illustrates the operational preparation start flag of the process device 3. It can be seen that the operational preparation is started at 03:00 on April 12 and a product is produced from 06:00 on the same day. This satisfies constraints of the operational preparation required time period (see symbol H in FIG. 15: 3 hours). There is no sign of starting the operational preparations unnecessarily early.

### Modified Examples

The operation plan creation devices 10 and 10A and the operation plan creation methods according to the first embodiment and the second embodiment have been described above. The operation plan creation devices 10 and 10A and the operation plan creation methods according to the first embodiment and the second embodiment are not limited to the above examples and can be modified in various forms.

In the first embodiment and the second embodiment, the process device 3 is a methanation device, but the process device 3 may be a device other than a methanation device. The process device 3 may be, for example, a hydrogen production system that produces hydrogen through water electrolysis. In general, water electrolysis is high in efficiency at a high temperature because a theoretical electrolytic voltage is lower at a higher temperature. Some hydrogen production system such as steam electrolysis of water-electrolyzing high-temperature steam requires a predetermined time period for an operational preparation thereof. The process device 3 may be a production device of olefins (ethylene or propylene) serving as a raw material of a resin or a plastic in addition to hydrogen or methane. The process device 3 may be an electric boiler or may be an electric furnace for melting scrapped iron or an electrolytic and electrical refining equipment for making crude iron from iron ore. The process device 3 may be a chemical process device, a plastic processing device for rolling or the like, a food processing device, a distillation device, or a heating furnace for surface heat treatment or the like.

The operational preparation required time period may be defined as a time period for performing various operations depending on the type of the process device 3. A process device requiring heat energy often requires a preparation time for temperature raising and/or pressure raising. When pipe warming is required so as not to cause water hammer in a pipe of steam or the like, a time therefor may be included in the operational preparation required time period. When a purge operation for replacing toxic gas in a tank with nitrogen and/or air is necessary before operation is started, a time for the purge operation may be included in the operational preparation required time period. When a water supply operation is necessary for start of operation, a time therefor may be included in the operational preparation required time period. When an operator needs to perform monitoring in the spot at the time of starting for reasons in security and laws, a moving time of the operator may be included in the operational preparation required time period. A time for a start checkup and/or recording operation which is performed before operation is started may be included in the operational preparation required time period. The start checkup includes check of a residual pressure, on-off check of a cock or the like, visual check of water leakage, and check of a water gauge. A cooling time and/or a depressurizing time may be included in the operational preparation required time period. A time required for an operational preparation of a storage device of a product which is produced by the process device instead of the process device itself may be included in the operational preparation required time period.

In the first embodiment and the second embodiment, the operational preparation required time period is designated by a user, but may be set in another form. For example, as the operational preparation required time period, a time up to a desired temperature may be automatically calculated in the energy management system (EMS) using a mathematical expression, a table function, and a statistical model prepared in advance based on information of the temperature of the process device 3 and/or the outside air temperature before an operational preparation is started. The operational preparation required time period may be changed using an elapsed time after the process device has stopped previously. When stop is scheduled in calculation in the optimization unit 152, constraint conditions may be constructed to create an operation plan such that different operational preparation required time periods depending on a time step intervals from stop to start of the operational preparation are provided.

In the first embodiment and the second embodiment, calculation resources do not need to be present in the spot, but the calculation resources may be present in cloud.

In the first embodiment and the second embodiment, a system that transmits and receives energy externally is referred to as a “microgrid 1” for the purpose of convenience. However, the type of the microgrid 1 is not limited to a single factory or company site. For example, the microgrid 1 may be an industrial complex including a plurality of factories.

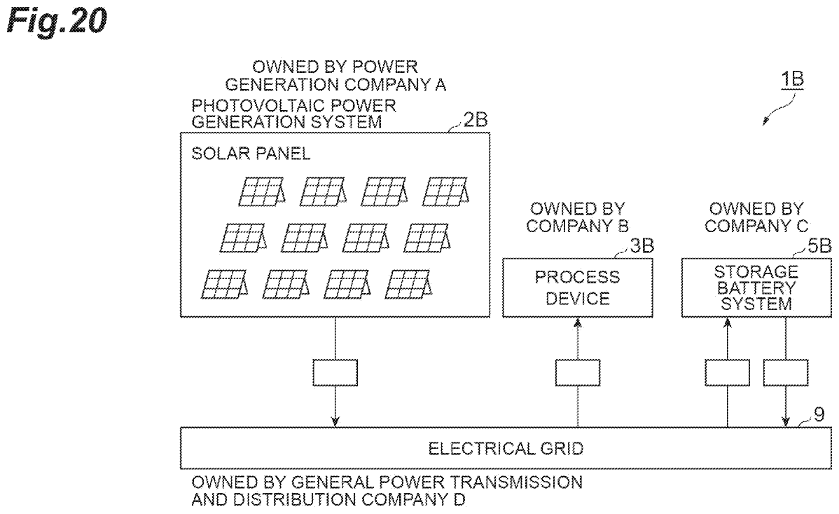

In the first embodiment and the second embodiment, all of the renewable energy generator, the storage battery system 5, and the process device 3 are present in one microgrid 1 as illustrated in FIG. 1. However, the configuration of the microgrid is not limited thereto. For example, a device group connected as illustrated in FIG. 20 may be considered as a virtual microgrid, and the operation plan creation devices 10 and 10A may be applied thereto. The microgrid 1B includes a photovoltaic power generation system 2B owned by a power generation company A, a process device 3B owned by a company B, and a storage battery system 5B owned by a company C. The photovoltaic power generation system 2B, the process device 3B, and the storage battery system 5B are connected to each other via an electrical grid 9. That is, the companies which own the system may be different. At this time, contracts between the companies may be a transaction via an electric power market or a crossing trade.

In the first embodiment and the second embodiment, for the purpose of simplification, it is assumed that electric power required for an operational preparation is zero. Based on the assumption that the electric power is sufficiently small, a plan is created with ignoring the electric power required for the operational preparation. However, electric power required for the operational preparation may be considered. For example, a condition in which predetermined power consumption is caused during an operational preparation may be added to the mathematical programming problem (PG). Expansion in this case is easy. Through this expansion, a problem in that electric power required for preheating and/or precooling is replenished with the surplus electric power pₛ can be solved.

In the first embodiment, only electric power based on renewable energy is considered as electric power supplied to the process device 3. For example, when the storage battery system 5 is provided as in the microgrid 1A according to the second embodiment, electric power supplied from the storage battery system 5 in addition to the electric power based on renewable energy may be considered as the electric power supplied to the process device 3. In the second embodiment, a charging/discharging plan of the storage battery system 5 in the mixed integer programming problem (PG) is also created along with the production plan of the process device 3. The charging/discharging plan of the storage battery system 5 may be created separately from the production plan of the process device 3.

In this case, the surplus electric power pₛ can be calculated using the plan of charging electric power and discharging electric power of the storage battery system 5 and the predicted value of the amount of electric power generated in the photovoltaic power generation system 2. For example, the renewable-energy surplus electric power calculating unit 112 may calculate the surplus electric power pₛ with electric power based on renewable energy and electric power supplied from the storage battery system 5 as input values.

A prediction unit of an operation plan creation device according to a modified example acquires a predicted value by predicting electric power output from a renewable-energy power generation device and acquiring a schedule indicating electric power output from the storage battery system 5 and electric power input to the storage battery system 5. With this configuration, it is possible to create an operation plan of the process device 3 that operates with electric power supplied from the photovoltaic power generation system 2 and electric power input to and output from the storage battery system 5.

For example, when the storage battery system 5 discharges electric power, the renewable-energy surplus electric power calculating unit 112 may consider that a surplus electric power pₛ is not generated and set the surplus electric power pₛ to 0. When the storage battery system 5 is charged with electric power, the renewable-energy surplus electric power calculating unit 112 may consider that a surplus electric power pₛ is generated and calculate the surplus electric power pₛ by subtracting the charging electric power of the storage battery system 5 from an amount of PV electric power. At this time, when the surplus electric power Pₛ has a negative value, the surplus electric power pₛ is set to 0. After the surplus electric power pₛ has been calculated, the operation plan creation device 10 according to the first embodiment can use the method of creating an operation plan of the process device 3.

The microgrid 1A according to the second embodiment includes a single storage battery system 5. The microgrid 1A may include a plurality of storage battery systems 5. Similarly, the microgrid 1A may include a plurality of process devices. It is easy to expand the mixed integer programming problem (PG) to a plurality of devices.

The second embodiment is based on the premise that the microgrid 1A includes the storage battery system 5. The operation plan creation device 10A according to the second embodiment may be applied to creation of an operation plan of a microgrid not including a storage battery system 5. In other words, the operation plan creation device 10A according to the second embodiment may be applied to creation of an operation plan of a microgrid including only the process device 3.

In the second embodiment, a total amount of production P in which the forgetting coefficient used in the first term of Expression (1) is reflected may be used to determine whether an operational preparation is started instead of the total amount of production. Determination of whether an operational preparation is started is not limited to the total amount of production P. For example, determination of whether an operational preparation is started may be performed based on the total amount of electric power consumed in the process device 3. This is because the amount of production has a correlation with the amount of consumed electric power.

The coefficient used in the first term of Expression (1) in the second embodiment is not limited to the forgetting coefficient in the form of power multiplication. As the coefficient used in the first term, a coefficient which decreases monotonously with the elapse of time can be used.

### ADDITIONAL REMARK

The present disclosure includes the following configurations.

The present disclosure is [1] “an operation plan creation device for creating an operation plan for a power load device that consumes some or all of electric power generated by a renewable-energy power generation device, the operation plan creation device creating the operation plan based on a predicted value of an amount of electric power generated using renewable energy and information of an operational preparation required time period required for the power load device to start operation in a producible state.”

The present disclosure is [2] “the operation plan creation device according to [1], wherein the operation plan includes a start time of an operational preparation of the power load device.”

The present disclosure is [3] “the operation plan creation device according to [2], wherein the operation plan includes an amount of power consumption or an amount of production of the power load device or both thereof.”

The present disclosure is [4] “the operation plan creation device according to [2], wherein an energy storage device is additionally provided and, when some or all of electric power discharged from the energy storage device is consumed by the power load device, the operation plan includes an amount of energy stored in the energy storage device, an amount of charging/discharging electric power, or both thereof.”

### Others

The operation plan creation devices 10 and 10A and the operation plan creation methods according to the first embodiment and the second embodiment relate to a technique that can activate production facilities effectively using surplus electric power based on renewable energy. Accordingly, the operation plan creation devices, the operation plan creation methods, and the operation plan creation programs according to the first embodiment and the second embodiment contribute to the following goals 7 and 9 of the sustainable development goals (SDGs) which are led by the UN.

Goal 7 “to guarantee all people's access to cheap, reliable, and sustainable modern energy”

Goal 9 “to achieve construction of resilient infrastructure, promotion of inclusive and sustainable industrialization, and promotion of innovation”

What is claimed is:

1. An operation plan creation device for creating an operation plan for a device that is able to switch from a non-producible state in which a product is not acquired even with inputting of electric power to a producible state in which a product is acquired with inputting of electric power by making an operational preparation, the operation plan creation device comprising:
a prediction unit configured to acquire a predicted value of an amount of electric power which is able to be supplied to the device and which includes electric power originating from renewable energy; and
a processing unit configured to create the operation plan based on the predicted value and an operational preparation required time period indicating a required time period for the operational preparation.

2. The operation plan creation device according to claim 1, wherein the operation plan includes a plurality of startable time candidates which are able to be selected as a time at which the operational preparation is started,
wherein the processing unit includes a total evaluation quantity calculating unit, and
wherein the total evaluation quantity calculating unit is configured to perform:
calculating a total evaluation quantity based on an amount of electric power consumed in the device to produce the product based on the predicted value and the operational preparation required time period based on the premise that the operational preparation is started at a startable time candidate selected out of the plurality of startable times for each of the plurality of startable time candidates;
extracting at least one total evaluation quantity indicating a maximum value as a maximum total evaluation quantity out of a plurality of total evaluation quantities acquired for each of the plurality of startable time candidates; and
selecting the startable time candidate corresponding to the at least one maximum total evaluation quantity as a first candidate which is a candidate for a time at which the operational preparation is started.

3. The operation plan creation device according to claim 2, wherein the processing unit further includes a total evaluation quantity determining unit, and
wherein the total evaluation quantity determining unit is configured to select at least one startable time candidate in which the maximum total evaluation quantity is equal to or greater than a threshold value as a second candidate out of the at least one first candidate by comparing the at least one maximum total evaluation quantity with the threshold value.

4. The operation plan creation device according to claim 3, wherein the processing unit further includes a start time determining unit, and
wherein the start time determining unit is configured to employ a latest time out of the second candidates as a start time at which the operational preparation is started when a plurality of the second candidates is selected by the total evaluation quantity determining unit.

5. The operation plan creation device according to claim 1, wherein the prediction unit acquires the predicted value by predicting electric power output from a renewable-energy power generation device.

6. The operation plan creation device according to claim 1, wherein the prediction unit acquires the predicted value by predicting electric power output from a renewable-energy power generation device and acquiring a schedule indicating electric power output from an energy storage device and electric power input to the energy storage device.

7. The operation plan creation device according to claim 2, wherein the total evaluation quantity is a total amount of production of the product which is produced by the device and calculated based on the amount of consumed electric power.

8. The operation plan creation device according to claim 2, wherein the total evaluation quantity is an amount of consumed electric power.

9. The operation plan creation device according to claim 1, wherein the processing unit includes:
a generation unit configured to prepare a programming problem including a term defined to include an amount of electric power consumed in the device to acquire the product in the device at a predetermined time and a term indicating whether the device is able to produce the product with reception of the electric power; and
an arithmetic unit configured to acquire a candidate for the operation plan by solving the programming problem.

10. The operation plan creation device according to claim 9, wherein the processing unit further includes an employment determining unit configured to employ the candidate for the operation plan as the operation plan when total evaluation value defined to include the amount of electric power consumed in the device and acquired based on the operation plan is equal to or greater than a threshold value.

11. An operation plan creation method of creating an operation plan for a device that is able to switch from a non-producible state in which a product is not acquired even with inputting of electric power to a producible state in which a product is acquired with inputting of electric power by making an operational preparation, the operation plan creation method comprising:
acquiring a predicted value of an amount of electric power which is able to be supplied to the device and which includes electric power originating from renewable energy; and
creating the operation plan based on the predicted value and an operational preparation required time period indicating a required time period for the operational preparation.
